(19) United States
(12) Patent Application Publication
(10) Pub. No.: US 2025/0259185 A1
(43) Pub. Date: Aug. 14, 2025

(54) Comprehensive Training and Contract Compliance Validation System and Method Thereof

(71) Applicant: Intelligent Partnerships, Inc., Las Vegas, NV (US)

(72) Inventor: Daniel J. Villao, Henderson, NV (US)

(21) Appl. No.: 18/440,190

(22) Filed: Feb. 13, 2024

(51) Int. Cl. G06Q 30/018; G06F 9/54; G06Q 10/0631

(52) U.S. Cl. CPC G06Q 30/018; G06F 9/547; G06Q 10/06316

(57) ABSTRACT

The present disclosure relates to a comprehensive training and contract compliance validation system and method thereof. In particular, the system may perform data aggregating operations to capture information from multiple sources including payroll, training, contract management and related information and reconfigure the aggregated data to customize reporting output for end users. In addition, the system may determine performance metrics by connecting the overall contract performance to individual performance tracking, allowing for ROI calculations and real-time contract compliance performance validation.

### FIELD OF THE INVENTION

The present disclosure relates to a comprehensive training and contract compliance validation system and method thereof. In particular, the system may perform data aggregating operations to capture information from multiple sources including payroll, training, contract management and similar information and reconfigure the aggregated data to customize reporting output for end-users. In addition, the system may determine performance metrics by connecting the overall contract performance to individual and/or group performance tracking, allowing for ROI calculations and real-time contract compliance performance validation.

### BACKGROUND

The 21st century workforce has seen a paradigm shift in how it aims to foster a more inclusive and accessible work environment. As it relates to market demand, approximately 94% of Gen-Z consumers expect brands to take a stand on social issues. Indeed, companies that ignore diversity in the workplace experience 30% losses in brand messaging. Still, U.S. businesses currently spend less than 6% of their supply budgets on minority suppliers, while the U.S. government is setting contract targets as high as 24%. In 2021 alone, the government collected over $5.6 billion from private companies for contract violations and inadequate compliance. Looking ahead, $48 billion in active Diversity, Equity, Inclusion and Accessibility (“DEIA”) investments are expected to increase by 13% through 2026. To that end, many private and public organizations across industries have been contractually incentivized to implement programs wherein diverse individuals are trained as apprentices with the goal of them becoming employed in their respective trade. To track the progress, compliance and financial output of such contracts and programs, these organizations currently use traditional methods of tracking and reporting.

Even so, current reporting systems only operate reactively to ensure contract compliance and do not provide multi-factor validation and metrics to proactively harness key data and visualize in real-time the progress made and value added by investing in DEIA assets and/or any other contract-based incentives.

Existing contract-based service organizations retrospectively extract this key data from multiple environments and manually generate CSV or XLS files for export into governmental or corporate reporting systems of all types. Each reporting element requires the entity reporting to create new files for each report based on the type of data that is being highlighted for the report and these duplicate or slightly varied reports must be filed in different configurations even when providing the information to the same organization.

For example, apprenticeship data as part of a contract-based, apprenticeship training service typically requires participation reports for completion and DEIA data, including demographic data. Reporting currently calls for separate filings, and though the information is about the same people and programs, the stakeholders must submit separate reports into the same system, causing the duplication and inefficiency issues described earlier. In addition, organizations are subject to audit on their performance and currently spend time preparing for these reviews. Further, compliance offices spend time evaluating the same information in different configurations, which is costly for all parties.

As a consequence, there is no dynamic and fluid system for measurement and reporting of key data about apprentices and other relevant individuals, such as employees or other individuals in a professional development program, and no streamlined mechanism to support contract compliance tracking or reporting.

Therefore, it is desirable to have a comprehensive training and contract compliance validation system for supporting many principal contract-based services among the vast array of industry sectors to rapidly demonstrate its adaptability to proactively and dynamically report in complex matrixed environments. Moreover, it is also desirable for the system to be optimally designed to generate cost and time savings for clients by centralizing a data repository which allows for the same information to be reconfigured and exported into a variety of reporting environments, overcoming the problems associated with conventional methods.

### SUMMARY

The following summary illustrates simplified versions of one or more aspects of the present disclosure. The purpose of this summary is to present some concepts in a simplified description as a more detailed description will be presented later.

A training and contract compliance validation system for managing at least one contract is reflected by embodiments of the present disclosure. In one aspect, the system may include a personas module for defining user roles, privileges, and security level clearances to manage, create, and operate features, functions, and tasks offered by the system. In another aspect, the system may include a web interface module serving as a primary portal through which personas may access apprenticeship resources and services facilitated by the system. In yet another aspect, the system may include an API module for executing one or more requests in the system. In yet another aspect, the system may include a reporting module for generating all pre-processed and pre-formatted reports tailored for each persona. In another aspect, the system may include an automation module for automating tasks and control via predefined syntax commands to conduct automated updates, additions, and verification of data to and from one or more modules in the system. In still yet another aspect, the system may include a data analysis module for determining at least an ROI indicator of the system. In yet another aspect, the system may include a cloud stored-mobile module for handling all file synchronization, storage, and backup services in the system. In still yet another aspect, the system may include a contract compliance module for handling and managing at least a return-on-investment performance, an apprenticeship training performance, and a project compliance associated with the at least one contract over time.

A computer-implemented method, executed by one or more processors in a computer network environment is reflected by another embodiment of the present disclosure. In one aspect, the method may include receiving a set of participant profile data from at least one participant associated with a contract, the contract involving a training program and an employment program, where at least one quantifiable value goal of the contract is predetermined. In another aspect, the method may also include supplementing the set of participant profile data with a pool of resource input data obtained from representatives within the training program and the employment program, including the at least one participant and at least one of a trainer or manager, as well as at least one representative outside of the training or the employment program (such as an outside HR/payroll representative). In yet another aspect, the method may also include reconciling, against the pool of resource input data, contract standards based on at least one of an individual education plan, a job readiness class requirement, a curriculum standard or an apprenticeship standard defined by a regulatory agency, and a particular contract requirement. In another aspect, the method may also include capturing at least one certification progress indicator associated with the training program and a level of performance data associated with the employment program. In still another aspect, the method may also include synchronously performing the receiving, supplementing, reconciling and capturing steps for the set of participant profile data associated with the training program and the employment program that are subject to the contract. In still another aspect, the method may also include using an algorithm to determine, in real-time, a return-on-investment indicator and a financial-competency indicator of the at least one participant over time for the contract based on the at least one quantifiable value goal, the at least one certification progress indicator and the level of performance data of the at least one participant. In still another aspect, the method may also include simultaneously and in real-time determining a contract validation indicator based on compliance with the contract standards. In still another aspect, the method may also include prompting a course-correction where the contract validation indicator is not achieved.

A non-transitory computer-readable storage medium reflecting one aspect of the present disclosure stores training and contract compliance validation instructions to be executed by one or more computer devices in the system. The program, when being executed, causes the one or more computing devices to perform the following steps. In one aspect, one step may include receiving a set of participant profile data from at least one participant associated with a contract, the contract involving a training program and an employment program, wherein at least one quantifiable value goal of the contract is predetermined. In another aspect, another step may include supplementing the set of participant profile data with a pool of resource input data obtained from representatives within the training program and the employment program, including the at least one participant and at least one of a trainer or manager, as well as at least one representative outside of the training or the employment program. In still another aspect, another step may include reconciling, against the pool of resource input data, contract standards based on at least one of an individual education plan, a job readiness class requirement, a curriculum standard or an apprenticeship standard defined by a regulatory agency, and a particular contract requirement. In still another aspect, another step may include capturing at least one certification progress indicator associated with the training program and a level of performance data associated with the employment program. In yet another aspect, another step may include synchronously performing the receiving, supplementing, reconciling and capturing steps for the set of participant profile data associated with the training program and the employment program that are subject to the contract. In yet another aspect, another step may include using an algorithm to determine, in real-time, a return-on-investment indicator and a financial-competency indicator of the at least one participant over time for the contract based on the at least one quantifiable value goal, the at least one certification progress indicator and the level of performance data of the at least one participant. In still yet another aspect, another step may include simultaneously and in real-time determining a contract validation indicator based on compliance with the contract standards. In yet another aspect, another step may include prompting a course-correction where the contract validation indicator is not achieved.

Additional features and benefits of the exemplary embodiments of the present disclosure will become apparent from the detailed description, figures and claims set forth below.

### BRIEF DESCRIPTION OF THE DRAWINGS

The present disclosure will be more clearly understood from the following detailed description of the embodiments of the disclosure and from the attached drawings, in which:

FIG. 1 shows a block diagram of a comprehensive training and contract compliance validation system, according to an embodiment.

FIG. 2 illustrates an example of types of personas in the personas module of the system, according to an embodiment.

FIG. 3 shows a block diagram of the Web Interface Module 100-2, according to an embodiment.

FIG. 4 illustrates the API Module of the system having application specific APIs for executing, performing, and managing apprenticeship programs, sessions, and courses, according to an embodiment.

FIG. 5 illustrates computer system architecture where data is communicated between and a cloud server over a public network, according to an embodiment.

FIG. 6 illustrates a schema of table resources (database objects) utilized by APIs and other system modules in the system, according to an embodiment.

FIG. 7 illustrates Reporting Module of the system, according to an embodiment.

FIG. 8 illustrates Automation Module of the system, according to an embodiment.

FIG. 9 illustrates Data Analysis Module of the system, according to an embodiment.

FIG. 10 illustrates the Cloud Stored-Mobile Module of the system, according to an embodiment.

FIG. 11 illustrates an implementation of the system as a workforce training model, according in an embodiment.

FIG. 12 illustrates a Contract Compliance Data Value Chain supported by the system, according to an embodiment.

FIG. 13 illustrates a Contract Compliance flowchart supported by the system, according to an embodiment.

FIG. 14 illustrates an application of a contract process in a construction contracting environment as supported by the system, according to an embodiment.

FIG. 15 illustrates a Task Analysis flowchart supported by the system, according to an embodiment.

FIG. 16 illustrates a CWA Pre-Job process supported by the system, according to an embodiment.

FIG. 17 illustrates a Service Blueprint flowchart supported by the system, according to an embodiment.

FIG. 18 illustrates a Sample Customer Management flowchart supported by the system, according to an embodiment.

FIG. 19 illustrates a method of apprenticeship contract compliance and performance validation executed by one or more processors in a computer network environment, according to an embodiment.

FIG. 20 illustrates another method of apprenticeship contract compliance and performance validation executed by one or more processors in a computer network environment, according to an embodiment.

FIG. 21 illustrates another method of apprenticeship contract compliance and performance validation executed by one or more processors in a computer network environment, according to an embodiment.

FIG. 22 illustrates another method of apprenticeship contract compliance and performance validation executed by one or more processors in a computer network environment, according to an embodiment.

FIG. 23 illustrates linked system modules of the apprenticeship contract compliance and performance validation methods operating under control of the system, in accordance to an embodiment.

FIG. 24 illustrates linked API modules of the apprenticeship contract compliance and performance validation methods operating under control of the system, in accordance to an embodiment.

FIG. 25 illustrates linked tables of the apprenticeship contract compliance and performance validation methods operating under control of the system, in accordance to an embodiment.

FIG. 26 illustrates linked personas of the apprenticeship contract compliance and performance validation methods operating under control of the system, in accordance to an embodiment.

FIG. 27 illustrates a block diagram of a computer structure in the system for executing processes, instructions, and methods therein, according to an embodiment.

FIG. 28 illustrates a block diagram of backend hardware and software components supporting the system, according to an embodiment.

FIG. 29 illustrates a top level network of the system, according to an embodiment.

### DETAILED DESCRIPTION

Aspects of the present disclosure are described herein, in the context of a system and methods for an apprenticeship contract compliance and performance validation. In particular, the system may operate under a unified platform having multiple modules operating therein which is streamlined to facilitate and integrate the origination, processing and resolution of apprenticeship contract compliance and performance validation.

Understanding one or more embodiments of the current disclosure is the aim of the following thorough description. Ordinarily skilled practitioners of the craft will recognize that the following thorough description is merely descriptive and not intended to be restrictive in any manner. Other embodiments will naturally occur to such skilled individuals after reading this disclosure and/or description.

Not all of the standard features of the implementations mentioned here are shown and detailed for the sake of clarity. Naturally, it will be understood that numerous implementation-specific decisions may be made during the creation of any such actual implementation in order to accomplish the developer's particular objectives, such as adherence to application- and business-related constraints, and that these particular objectives will vary from one implementation and one developer to another. Furthermore, it should be noted that even while such a development effort would be complicated and time-consuming, it would still be an ordinary engineering task for someone with the benefit of this disclosure's embodiment(s).

The drawings depicting the various embodiments of the current disclosure might not be drawn to scale. Instead, for clarity, the sizes of the individual features may be increased or decreased. Additionally, for clarity, some of the illustrations can be simplified. As a result, not every part of a certain apparatus (such as a gadget) or process may be shown in the pictures. The same or similar parts will be referred to using the same reference indicators throughout the drawings and the accompanying thorough description.

A system for managing comprehensive training and contract compliance validation that includes at least one of a CPU, processor, state machine, logic, memory, discrete hardware and/or any combination thereof to conduct training and contract compliance validation as mentioned here is disclosed in various exemplary implementations.

### System Overview

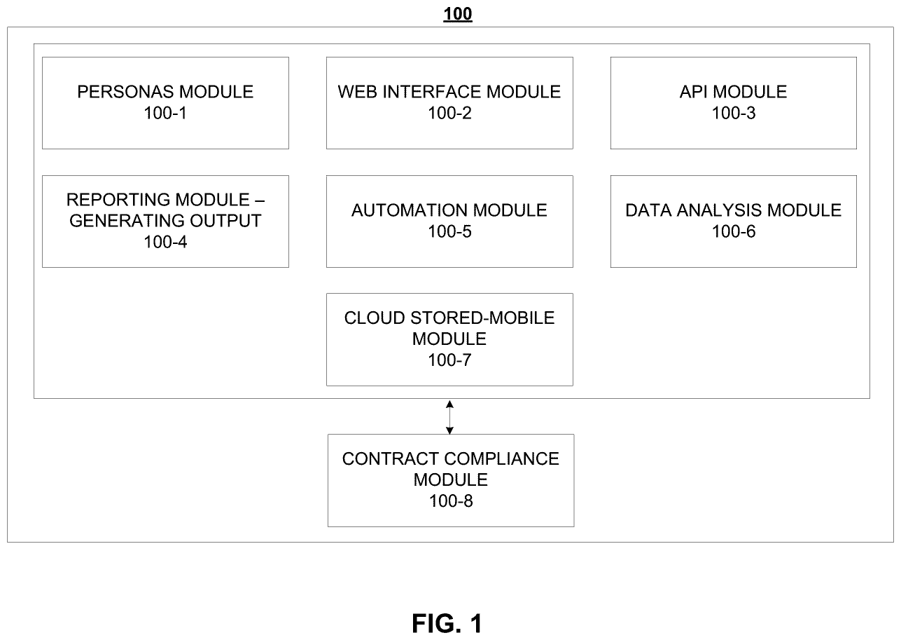

FIG. 1 shows a block diagram of a comprehensive training and contract compliance validation system 100, according to an embodiment. In an exemplary embodiment, the system 100 comprises a Personas Module 100-1, Web Interface Module 100-2, API Module 100-3, Reporting Module 100-4, Automation Module 100-5, Data Analysis Module 100-6, Cloud Stored-Mobile Module 100-7, and Contract Compliance Module 100-8. Implementations of these independent modules (100-1 through 100-8) may include a cloud-based network of remote or local hardware, firmware, software components, or a combination thereof acting either independently or dependently from one another and communicating data between modules to facilitate processing and managing work flow of the entire system 100. In one aspect of the system 100, the Web Interface Module 100-2 serves as a primary portal through which internal and external users may access apprenticeship resources and services facilitated by the system 100. These resources and services may include but are not limited to account creation and maintenance, data submissions, data verification, training, and so on. In another aspect, users of the system 100 may be grouped into personas module 100-1 assigned to pre-defined users of the system, having designated roles and different authorization levels which allow them to access, maintain, update, and/or generate reports. In another aspect, core functional operations of the system 100 are primarily handled and processed by the API Module 100-3 which serves as the primary engine driving and executing all modules in the system. In yet another aspect, the Reporting Module 100-4 is responsible for generating all pre-processed and pre-formatted reports tailored for each persona including but not limited to apprenticeship reports, coordinator reports, certifier reports, analytic reports for targeted end users. In another aspect, the Automation Module 100-5 of the system 100 may utilize automation tasks via synchronization, automatic generation, job schedulers (CRON), and automatic trigger events to reduce the need for human intervention, thereby creating automated actions out of recurring and routine processes performed by the other modules in the system 100. In yet another aspect, the Data Analysis Module 100-6 of the system 100 serves as a real-time analysis tool for determining system usage and patterns such as, but not limited to, apprentice drop rates, usage times, comparative analysis of apprenticeship and employment related data obtained by the web interface (or intake) module 100-2. In still another aspect, one or more hardware, software, and/or network portions of the system 100 may reside and fully operate in a remote platform via the Cloud Stored-Mobile Module 100-7, allowing full scalability of the system 100 to function optimally and dynamically under changing or rising workloads or demand which provides flexibility, dependability, and competitiveness in a changing client-centric economic cycle. Operationally, modules (100-2 through 100-8) in the system 100 can be separated into one or more presentation layers (frontend) and data access-management layers (backend) supported by software based applications and/or physical infrastructure or hardware.

Advantageously, the system 100 can facilitate apprenticeship functions via a unified platform by which: 1) apprenticeship-based entities may design and create programs, certifications, and tasks for enrolled apprentices; 2) enrolled participants may manage their course work, track their progress, and communicate with instructors and/or supervisors from within the same platform; 3) sponsors and/or stakeholders may track completion rates, hours, money spent and other metrics around apprenticeships to gauge return-on-investments (ROIs) for these programs.

### Definitions

| Element | Definition | Example |
|---|---|---|
| Agreement | A type of Contract | The buyer (IP Client) |
| | that includes all | issues a contract to |
| | of the measurable | purchase a new |
| | components or | building/road/bridge/ |
| | elements the | hospital/hotel or similar |
| | contractor/supplier/ | construction purchase. |
| | provider is | Within the contract, the |
| | responsible for | buyer includes all of the |
| | beyond the actual | elements that should be |
| | purchase. | included in the building |
| | | itself and certain |
| | | conditions that are |
| | | required in order to |
| | | fulfill the intended |
| | | purpose/mission/value the |
| | | project will add to the |
| | | community/organization. |
| | | These conditions can |
| | | include a requirement to |
| | | use a percentage of local |
| | | contractors, workers, or |
| | | meet demographic criteria |
| | | like low-income, |
| | | disadvantaged, veterans, |
| | | women or similar |
| | | participants in the |
| | | workforce that constructs |
| | | the facility. |
| Apprenticeship | A framework | The apprenticeship |
| Standard | defining the | standard specifies the |
| | criteria and | required competencies and |
| | expectations for | assessment methods. |
| | apprenticeship | |
| | programs. | |
| Buyer/Purchaser | Person who buys or | |
| | agrees to buy goods | |
| | or services; a | |
| | party to a contract | |
| | of SALE. | |
| Certification | A measure of a | The certification progress |
| Progress | participant's | indicator shows that Mark |
| Indicator | progress toward | is 80% complete in his IT |
| | achieving | certification after six |
| | certifications or | months. |
| | qualifications. | |
| Client | The project the | |
| Engagement | purchaser hired to | |
| | support compliance | |
| | activity or the | |
| | project the | |
| | purchaser will be | |
| | using the system as | |
| | a support for | |
| | compliance. | |
| Community | CWAs are a specific | |
| Workforce | type of PLA that | |
| Agreements | includes community- | |
| (CWAs) | oriented | |
| | commitments | |
| | relating to | |
| | equitable workforce | |
| | development, social | |
| | justice, small | |
| | business support, | |
| | and/or other | |
| | issues. | |
| Contract | A formal agreement | The contract specifies the |
| | that outlines the | duration, goals, and |
| | terms and | responsibilities of the |
| | conditions of the | employer, contractor or |
| | work delivery | sub-contractor. |
| | requirements | |
| | including workforce | |
| | conditions of | |
| | employment | |
| Contract | A condition or | The contract requirement |
| Requirement | obligation that | includes regular progress |
| | must be fulfilled | reports and evaluations. |
| | as part of the | |
| | apprenticeship | |
| | contract. | |
| Contract | Defined guidelines | The contract standards |
| Standards | and requirements | mandate a minimum of 700 |
| | that must be | hours of minority trainee |
| | followed within the | employment utilization for |
| | procurement | the employer to receive |
| | contract. | credit for the |
| | | disadvantaged worker hire. |
| Contract | The process of | Contract validation |
| Validation | ensuring that the | involves reviewing the |
| Indicator | contract | contract performance to |
| | performance meets | confirm compliance with |
| | all procurement, | wage, sub-contracting and |
| | legal and | similar standards. |
| | regulatory | |
| | requirements. | |
| Course- | Adjustments or | When a sub-contractor |
| Correction | changes made to the | struggles, course- |
| | program or | correction may involve |
| | participant's plan | additional interventions |
| | when progress veers | or the introduction of |
| | off track. | alternative sub- |
| | | contractors to meet |
| | | performance obligations. |
| Curriculum | A set of predefined | The curriculum standard |
| Standard | educational | outlines the topics |
| | objectives and | covered in the software |
| | content for a | engineering course. |
| | specific course or | |
| | program. | |
| Employment | A program that | The employment program |
| Program | provides job | helps apprentices find job |
| | placement or | opportunities after |
| | employment support | completing training. |
| | for participants. | |
| Employer | An entity or | XYZ Company recruits |
| | organization that | plumber Perry and provides |
| | provides the On The | him with on the job |
| | Job Training | plumbing training to |
| | component of an | become a certified or |
| | apprenticeship | licensed plumber for a |
| | and/or training to | construction project at a |
| | enhance | specific wage. |
| | occupational | |
| | competencies, and | |
| | provides full time | |
| | employment for | |
| | multiple | |
| | occupations at | |
| | various wage rates | |
| | in contract | |
| | environments for | |
| | the purposes of | |
| | compliance | |
| | monitoring within | |
| | the contract. | |
| Financial- | A measurement of | ABC Company demonstrated a |
| Competency | the employer's | $2M increase in local |
| Indicator | financial impact | contractor spending while |
| | and management | creating 1000 new jobs for |
| | skills. | the local workforce. |
| Individual | A personalized | Jane's individual |
| Education | learning plan | education plan includes |
| Plan | tailored to each | courses in web development |
| | participant's needs | and project management. |
| | and goals. | |
| Job | A specific class or | The job readiness class |
| Readiness | training module | requirement covers resume |
| Class | designed to prepare | building and interview |
| Requirement | participants for | skills. |
| | employment. | |
| Level of | Data indicating how | XYZ Company is meeting |
| Performance | well an employer is | veteran utilization |
| Data | performing in their | requirement of 5% monthly |
| | contract compliance | but is 2% below its |
| | obligation. | commitment to use 10% |
| | | women owned businesses in |
| | | its contract delivery. |
| On The Job | A training program | The plumbing |
| Training | that includes paid | apprenticeship program |
| Program | work exposure to | includes on the job |
| (OJT) | the occupation. | training to meet licensing |
| | | requirements. |
| Outside | An external | An industry expert serves |
| Representative | stakeholder who may | as an external |
| (of the | be involved in the | representative to provide |
| Training or | participant's | feedback on apprenticeship |
| Employment | journey or program | quality. |
| Program) | evaluation. | |
| Participant | An individual | Sarah is a participant in |
| | employee AND/OR an | the apprenticeship |
| | individual enrolled | program. Sarah works for |
| | in an | XYZ company. |
| | apprenticeship, | |
| | training or employment program. | |
| Participant | Data containing | John Doe's participant |
| Profile Data | information about a | profile includes his |
| | participant or | contact information and |
| | multiple | educational background. |
| | participants, such | |
| | as their name, | |
| | contact details, | |
| | skills, and | |
| | qualifications. | |
| Policy(ies) | In Government | Age policy is one example |
| | contracts and in | of a limitation that the |
| | Corporate | organization will follow |
| | purchasing a | the legal standard that no |
| | procurement and | child under 16 years old |
| | final agreement | can perform certain work |
| | will likely be | then any responding |
| | influenced by | contractor would need to |
| | policy(ies). These | acknowledge and avoid |
| | are pre-determined | hiring minors to perform |
| | rules outside of | work in agreements that |
| | the contracting | require certain work. This |
| | environment that | can be a point of |
| | set standards the | compliance measurement, |
| | public or | verification that the |
| | leadership has | contractor has been |
| | established that | notified accepted and is |
| | must be part of any | in fact following the |
| | purchase agreement | policy during the life of |
| | the organization is | the project/agreement. |
| | involved in. | |
| Pool of | A collection of | The electrical |
| Resource | resources like | apprenticeship program |
| Input Data | materials, | provides tools, boots and |
| | instructors, | bus passes to first year |
| | information on | apprentices. |
| | progress/milestones/ | |
| | time-lapse for | |
| | determining | |
| | financial and ROI | |
| | metrics, and | |
| | equipment used in | |
| | the program. | |
| Procurement | The process by | |
| | which the contract | |
| | is up for bid and | |
| | awarded. This | |
| | typically is | |
| | advertised to | |
| | demonstrate what | |
| | the purchaser would | |
| | like to build and | |
| | the conditions that | |
| | need to be met in | |
| | order to be | |
| | compliant with the | |
| | contract. | |
| Procurement | Defined guidelines | The city purchasing |
| Contract | and requirements | department has issued a |
| | that are issued by | procurement contract to |
| | a corporate or | XYZ Company to build their |
| | government | new police station. |
| | purchaser. | Example 2: ABC Corp has |
| | | issued a procurement |
| | | contract to buy 1000 new |
| | | smartboards for their |
| | | headquarters. |
| Procurement | The Corporate or | The Minnesota Department |
| Office | Government office | of Transportation (MNDOT) |
| | responsible for | is responsible for all |
| | issuing procurement | transportation related |
| | contracts | procurement contracts |
| Project | A pre-hire | |
| Labor | collective | |
| Agreement | bargaining | |
| (PLA) | agreement with one | |
| | or more labor | |
| | organizations that | |
| | establishes the | |
| | terms and | |
| | conditions of | |
| | employment for a | |
| | specific | |
| | construction | |
| | project. | |
| Quantifiable | A measurable | The goal of the training |
| Value Goal | objective within | contract is for the |
| of the | the training | apprentice to achieve 90% |
| Apprentice- | contract that both | proficiency in coding |
| ship | parties aim to | skills. |
| Contract | achieve. | |
| Quantifiable | A measurable | The goal of the contract |
| Value Goal | objective within | is for the employer to |
| of the | the contract that | achieve 20% utilization of |
| Contract | both parties aim to | women as apprentices. |
| | achieve. | |
| Receiving, | A series of stages | The receiving step |
| Supplementing, | or processes | involves collecting |
| Reconciling, | involved in | participant documents, and |
| and | managing resources | the reconciling step |
| Capturing | and information | verifies their accuracy. |
| Steps | within the program. | |
| Regulation/ | Like policies these | |
| Regulatory | are pre-defined | |
| Requirement | conditions that | |
| | need to be met by | |
| | participants of the | |
| | system. However, | |
| | for | |
| | regulation/regulatory | |
| | requirements the | |
| | difference is | |
| | backed by | |
| | enforceable | |
| | statute, legal | |
| | requirements and | |
| | may be subject to | |
| | penalties including | |
| | fines and/or | |
| | arrest. | |
| Regulatory | A government or | The state department of |
| Agency | industry authority | Labor & Industry regulates |
| | that oversees and | employment wages for |
| | regulates contract, | occupations. |
| | employment or | |
| | business wages and | |
| | licensing. | |
| Representatives | Individuals or | The program |
| (within | personnel | representatives include |
| the Training | responsible for | trainers, mentors, and |
| and | overseeing and | career counselors. |
| Employment | assisting | |
| Program) | participants. | |
| Return-on- | A metric used to | The return-on-investment |
| Investment | assess the | indicator shows that the |
| Indicator | effectiveness and | program led to a 20% |
| | value of the | increase in the number of |
| | investment in the | clients in the |
| | apprenticeship or | participants portfolio of |
| | training program. | work. |
| Stakeholder | A person, group, or entity having a | Contract managers, |
| | direct interest in | contractors, |
| | a business or | subcontractors, TPA, |
| | investment related | owners, etc. |
| | matter. | |
| State | A government or | The Department of Labor is |
| Apprenticeship | industry authority | the regulatory agency |
| Agency | that oversees and | responsible for registered |
| (SAA) OR | regulates | apprenticeships. |
| Office of | registered | |
| Apprenticeship | apprenticeship | |
| (OA) | programs. | |
| Third Party | This is a for-hire | |
| Administrator | role. The TPA may | |
| (TPA) | organize the | |
| | policies and | |
| | implementation on | |
| | behalf of the | |
| | owner. The function | |
| | validates or | |
| | reviews the | |
| | reported | |
| | information or may | |
| | directly capture | |
| | the data in the | |
| | contracts being | |
| | performed. The | |
| | owner may also | |
| | manage the | |
| | compliance process | |
| | internally on its | |
| | own. | |
| Training | A condition or | The contract requirement |
| (Contract) | obligation that | includes regular progress |
| Requirement | must be fulfilled | reports and evaluations. |
| | as part of the | |
| | apprenticeship | |
| | contract. | |
| Trainer or | A person | The coding trainer helps |
| Manager | responsible for | apprentices improve their |
| | instructing and | programming skills. |
| | guiding | |
| | participants in | |
| | their learning | |
| | journey. | |
| Training | A structured | The IT apprenticeship |
| Program | educational program | program focuses on |
| | designed to develop | software development |
| | specific skills or | skills. |
| | competencies. | |

### Personas

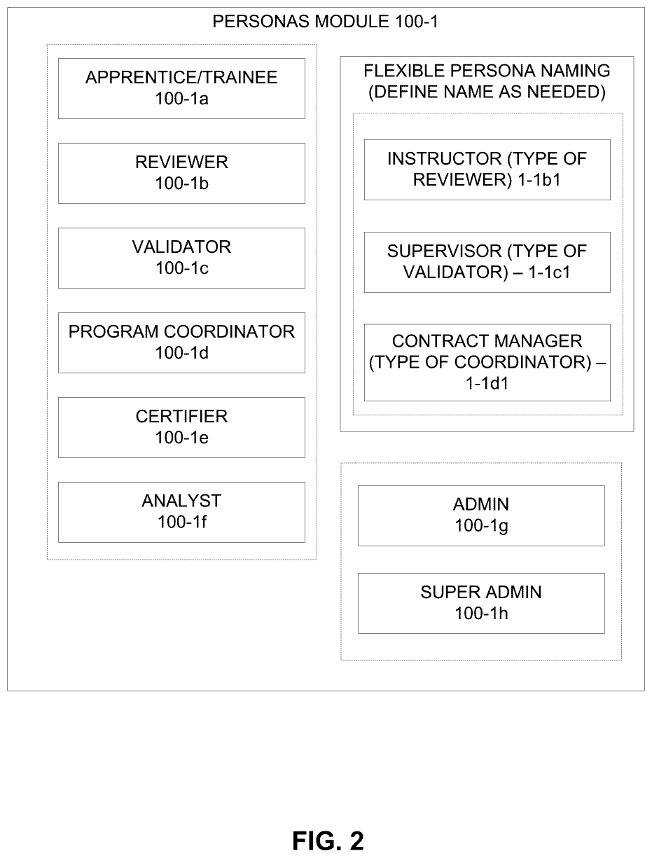

FIG. 2 illustrates an example of types of personas in the personas module 100-1 of the system 100, according to an embodiment. Personas may include users of the system 100 who have pre-defined roles, privileges, and security level clearances to manage, create, and operate features, functions, and tasks offered by the system 100. In some embodiments, roles can be divided into a worker-type category and validation-type category. A worker-type persona is any person participating as an employee regardless of capacity or supervision level, including employees in a training capacity. The system 100 provides the worker-type persona with limited system access and privileges, allowing that persona to interact with the relevant stakeholders and system features tied to that worker's function in the respective program. A validation-type persona participates in the validation of one or more phases of a worker's training or employment-related program. For example, types of personas may include but are not limited to a worker-type persona such as an Apprentice/Trainee 100-1a, as well as a validation-type persona such as a Reviewer 100-1b, a Validator 100-1c, a Program Coordinator 100-1d, a Certifier 100-l, and an Analyst 100-1f. Still, no restrictions are applied to the naming convention selectively applied to each persona where users of the system may customize persona names according to their specific needs. For example, a “Foreman”, “Journeyperson”, “Journeyworker”, “team lead” or similarly themed persona title (not pictured) may be akin to a worker-type persona for tracking purposes. And if that “Foreman” is also supervising a particular Apprentice and validates that Apprentice's tasks, the Foreman may function as a validation-type persona as well. As a further example, customized persona names may include an Instructor 100-1b1 (a type of reviewer), a Supervisor 100-1c1 (a type of validator), and a Contract Manager 100-1d1 (a type of program coordinator). Other personas may include system support or third-party roles such as an Admin 100-1g and Super Admin 100-1h. Importantly, tracking is not contingent on the naming convention applied to a persona; rather, the role of the individual is what prompts certain tracking and qualifies the individual as a worker-type or validation-type persona.

### Apprentice/Trainee

An apprentice/trainee may be any person who is enrolled in the system 100 and participates in an apprenticeship program for a trade or profession via apprenticeship training courses that combines in-class instruction with practical hands-on experience. In one aspect, the system 100 provides the apprentice limited system access and privileges allowing them to register, enroll, and take courses to develop career skills and earn credits for certification in a particular field of choice available in the system. Through their initial enrollment as an apprentice, the system 100 collects at its frontend qualifying information of the enrolled apprentice which may include but is not limited to the apprentice's name, contact information, education, household income, national origin, language, race, color, disability, ethnicity, gender, age, religion, sexual orientation, gender identity, socioeconomic status, veteran status, and family structures, and other background information.

### Reviewer

A reviewer may be any trained personnel given access and authorization by the system 100 to review course work and material submitted by the apprentice. In one aspect, the reviewer insures the apprentice submits the correct tasks according to guidelines and requirements defined by a certification for a given program.

### Validator

A validator may be any trained personnel given access and authorization by the system 100 to validate work performed by the reviewer. In one aspect, the validator insures that the reviewer is doing their job acting as QA to reviewer and performing a two-step validation process.

### Program Coordinator

A program coordinator may be any trained personnel given access and authorization by the system 100 for overseeing the apprenticeship programs that are being conducted by one or more external clients or entities (e.g., companies, government agencies, universities) whose training programs they are assigned to manage. In one aspect, the program coordinator has authority and control to invite designated personas (e.g., instructors, supervisors, contract managers, and apprentices) for the companies they manage, create programs, create certifications for programs, create course-based activities for certifications, create time-based activities for certifications, create program sessions, and assign personas to program sessions.

### Certifier

A certifier may be any trained personnel given access and authorization by the system 100 for approving certifications once the Program Coordinator 100-1d has created and released a certification. In other words, the certifier is a persona that approves certifications once the program coordinator has finished creating a certification. Other types of certifiers may include other personas such as but not limited to Instructor 100-1e1, Supervisor 100-1e2, and Contract Manager 100-1e3. For example, Instructors 100-1e1 may include teachers that are assigned to teach Certifications that belong to a specific Program Session, Supervisors 100-1e2 may include personas that oversee and approve (or reject) an Apprentice's performance on a “Hands-On” task, and Contract Managers 100-1e3 may include personas that assign a Supervisor to oversee an Apprentice's performance on a “Hands-On” task for a specific day.

### Analyst

An analyst may be any trained personnel given access and authorization by the system 100 for reviewing/exporting reports, creating customized reports and analyzing data or customer number.

### Admin

An admin may be any trained personnel given access and authorization by the system 100 having local system administration authority allowing them privileges to make local system changes within the entity (company, government agency, or university). In one aspect, the Admin 100-1g has local access and control of network and computer systems, including local administrators installation, configuration, and maintaining local computer networks and systems.

### Super Admin

A super admin may be any trained personnel given access and authorization by the system 100 having full system administration authority across all entities allowing them privileges to make global system changes across different modules. In one aspect, the Super Admin 100-1h has full authority and privileges, which provide that persona the ability to access and control the system 100 installed on other entity networks and computer systems, including for local administrators installation, configuration, and maintaining computer networks and systems.

### Web Interface Module

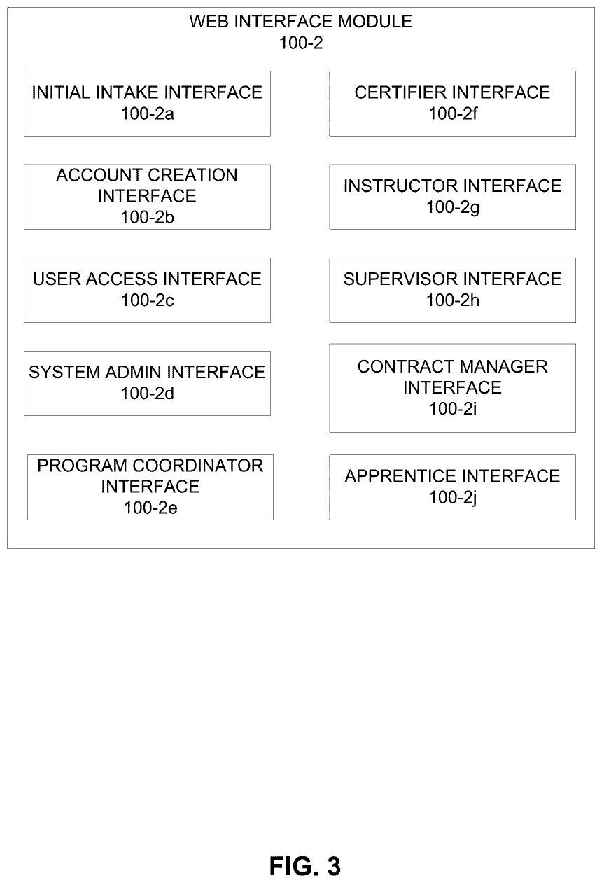

FIG. 3 shows a block diagram of the Web Interface Module 100-2, according to an embodiment. In an exemplary embodiment, the Web Interface Module 100-2 may include dynamic documents processed and communicated over a network server, and grouped into sub-interfaces through which internal and external users may interact with the system 100 that provides apprenticeship based programs. Advantageously, users (e.g., Apprentices) may conduct apprenticeship programs to operate via one consolidated online based system. In some implementations, the Web Interface Module 100-2 may include a browser or an application (“app”) based user interface which is accessible over the Internet via network computing devices such as, but not limited to, a computer, laptop, tablet, or mobile device (e.g., smartphone or PDA). These sub-interfaces may include at least an Initial Intake Interface 100-2a, Account Creation Interface 100-2b, User Access Interface 100-2c, System Admin Interface 100-2d, Program Coordinator Interface 100-23, Certifier Interface 100-2f, Instructor Interface 100-2g, Supervisor Interface 100-2h, Contract Manager Interface 100-2i, and Apprentice Interface 100-2j.

### Initial Intake Interface

In one aspect of the Web Interface Module 100-2, the Initial Intake Interface 100-2a, is a frontend application serving as an initial web interface entry point to the system 100, presenting introductory and brief overview information of apprenticeship and employer resources available to potential clients and benefits thereof. Potential clients may also be offered quick tutorials on apprenticeship programs and employer tools, allowing these potential clients to provide feedback on which apprenticeship programs or tools they are seeking via polling or online questionnaires. Access to all apprenticeship and employer services (apprentice and employer registration, login, training, reporting, etc.) are made available by the Initial Intake Interface 100-2a via forwarding links.

### Account Creation Interface

In another aspect, the Account Creation Interface 100-2b of the Web Interface Module 100-2 is another frontend user application which collects, registers, and stores at the backend personal identifiable information (PII) of a new user. The user is categorized by persona type which collects user-dependent information based on the persona identification and determines security level criteria associated therewith. A process validation for identifying new users may be accomplished via a two-step authentication method including but not limited to an email link, Short Message/Messaging Service (SMS), and/or voice verification.

### User Access Interface

In another aspect, the User Access Interface 100-2c of the Web Interface Module 100-2 is another frontend user application which provides access to external users (e.g., customers, companies, contractors, TPAs, stakeholders) of the system 100. The User Access Interface 100-2c may send or receive information from external users, including pay data, performance data used for ROI calculations).

### System Admin Interface

In another aspect, the System Admin Interface 100-2d of the Web Interface Module 100-2 is another frontend user application which allows an authorized system administrator on behalf one or more entities (e.g., company, university, government agency) to perform system level tasks such as, but not limited to, new company creation and definition, new user invitations, and modifying existing companies and accounts to the system 100. For example, the system administrator can add, remove, and archive companies to the platform via input forms including but not limited to a company name, company address, description, industry type, point of contact email, point of contact phone number, employee types, and invite/dis-invite options of users to the platform. Ancillary company information may also include wages, occupation and pay rates. In addition, the system administrator has full control of process intake for accepting company invites via approval/disapproval links which can trigger the flow for the system administer to approve the request.

### Program Coordinator Interface

In another aspect, the Program Coordinator Interface 100-2e of the Web Interface Module 100-2 is another frontend application which restricts access to a designated persona (e.g., program coordinator) who is assigned to manage the training program(s) of one or more entities (e.g., a single company or companies), allowing the program coordinator to perform apprenticeship management tasks and functionalities within this interface. For example, these tasks may include but are not limited to handling and overseeing apprenticeships that are being conducted by the one or more companies and inviting other personas (e.g., Instructors, Supervisors, Contract Managers, and Apprentices) that are managed by the program coordinator who assigned to the one or more companies. In addition, a company overview section of the Program Coordinator Interface 100-2e is responsible for displaying and summarizing all programs offered by the company and registered personas in the company (i.e., Instructors, Supervisors, Contract Managers, and Apprentices) which are managed by the program coordinator.

Other functionalities offered by the Program Coordinator Interface 100-2e may include but are not limited to creating programs, creating certifications for programs, creating course based activities for certifications, creating time based activities for certifications, creating program sessions, and assigning personas to program sessions.

### Programs

A program is comprised of one certification or a set of certifications for a focus career area that serves to prepare and qualify an apprentice for a job in the focus career area. A program may be time-based (experience gained in combined on-the-job and classroom training), competency-based (completion through a series of competencies demonstrated through testing, performance, or certification obtainment), or a hybrid model combining both time and competency elements to complete occupational competency. In some aspects, different entities or companies can offer the same program while one company can offer just one unique program. In other aspects, multiple companies can participate in a program in a multi-employer plan while large companies may have multiple programs for a single-employer plan.

A program may be created by defining a program name and a program description in a program creation view of the Program Coordinator Interface 100-2e. Once the program is created, one or more certifications may be added to the newly created program. Once the program starts, certifications can no longer be added in some instances.

The Program Coordinator Interface 100-2e may also include a program details view which displays the program name, the program description, and one or more certifications that make up the program. The program details view may also provide publish status (published/unpublished) information of the program and all active program sessions for the viewed program and specific company.

### Certification

A certification is a set of “tasks” typically in the form of physical assignments or courses that an apprentice must complete in order to earn credits for a program in which they are enrolled. Certifications may also be awarded based on knowledge demonstrated through testing. For example, physical assignments may include “On-the-Job” and “Hands-On” tasks which are typically time based (e.g., Weld Left-Joints for 10 hours). In application, an apprentice may complete an assigned physical task having a set amount of time and then submit “time cards” which is approved by a supervisor in order to receive credits for the program.

Courses in certifications are similar to traditional classes and lectures and may include but are not limited to in-class instructions, video instructions, and personal tutorials with the certifier persona (e.g., instructor of a course). Upon completion of the course and approval by the instructor, the apprentice can receive course credits for the program in which they are enrolled. In addition, certifications may or may not be specific to a program whereby many programs can offer the same certification. For example, programs may be the same at the high level (e.g., Plumber Programs), but certifications may be different as they may come from different states (California vs New York).

### Creating a Certification

Certifications are created by the program coordinator and always one-to-one with a program that is offered in the system 100. In one instance, a pre-existing certification may be already available in the Program Coordinator Interface 100-2e and selected from a list of certifications available for the company that is managed by the program coordinator. When creating a certification in the Program Coordinator Interface 100-2e by the program coordinator, basic setup information is required which may include a certification name and a certification description. Once a certification is created and available in the interface, course tasks and hands-on tasks can be added and linked to the certification.

Adding one or more course tasks in the Program Coordinator Interface 100-2e by the program coordinator requires at least a course title, course description, course task type, course content material (e.g., lecture video), course assignment (e.g., document), and course test materials (e.g., exams and quizzes) which can be uploaded via the interface. For example, if the course task is a video lecture, the task creation will have another form section into which a program coordinator can upload a video of the lecture. If the task is a quiz, the program coordinator can create the quiz directly through the interface, which can consist of the following:
1. Short answer questions (text input only)
2. Numerical answer questions (numeric input only)
3. Text answer questions (text input only)
4. Multiple choice (single select input only)

Adding one or more hands-on tasks in the Program Coordinator Interface 100-2e by the program coordinator requires at least a hands-on title, hands-on description, and hands-on task time requirement. Tasks that are created and added by the program coordinator are locked and cannot be edited unless the certification is withdrawn by the program coordinator.

### Certification Approval

Once all the tasks are added, the Certification can be previewed and then submitted by the program coordinator to be reviewed by the certifier.

In one aspect, the certifier is provided a certification approval form by which certifications are approved by the certifier. Notably, once a certification is submitted for approval, it is frozen and cannot be edited unless withdrawn by the program coordinator as previously noted.

### Publishing a Program

A program having approved certifications is ready for publication by the program coordinator. Once the program is published, it is finalized, and once the program is populated with the desired certifications, and they are all approved by the certifier, the program coordinator can publish the program. Subsequently, the program coordinator is provided a program publishing form by which programs may be selected for publication by the program coordinator. A confirmation modal will appear confirming the program is now ready for enrollment by apprentices having interest in certifications offered in the program.

### Program Sessions

Within a designated program, certifications may be achieved through completion of certain sessions, sometimes called certification sessions or program sessions. Program sessions encompass a specific program having personas and certification components. For example, the program coordinator can initiate a program session for a published program via a program view form which is only available to the program coordinator. In the program view form, predefined personas may be added to a program session which may include four of the major personas (Apprentices, Instructors, Supervisors, and Contract Managers). An additional security and verification layer (i.e., access point) may be required for dispatchers who have access to the app and can verify an apprentice has been dispatched to work, date, time, level of apprentice and any demographic or membership issue available (e.g., gender, contract type, zip code hire, etc.).

When assigning apprentices to program sessions, the program coordinator can add apprentices who appear in a selectable list via the program view form. The program coordinator may scroll through a list of available apprentices for a company, selecting and assigning all desired apprentices.

Instructors may be assigned and added to specific certifications by the program coordinator inside the program session via the program view form. Under the certification option in the program view form, the program coordinator may scroll through a list of available instructors, selecting and assigning all desired instructors to one or more certifications.

In a similar fashion, supervisors and contract managers may be assigned and added to specific certifications by the program coordinator inside the program session via the program view form. In one instance, supervisors are assigned in the certification option inside the program view form in the program session. In particular, supervisors are assigned on a per task basis, where different tasks may be assigned with different supervisors. For all hands-on tasks, the program coordinator can select and assign supervisors to each hands-on task provided in a selectable list via the program view form. If any task does not have a pre-assigned supervisor, then it must be assigned by an appropriate persona, who will assign the apprentice to a specific supervisor when the apprentice logs and enters their time into the system for the “hands-on” task they have just performed. In practice, supervisors are generally assigned at the worksite, while the contract manager generally knows where the worker (apprentice) was sent and who they are to report to start working. The program coordinator can select and assign the appropriate individuals to each hands-on task provided in a selectable list via the program view form.

### Certification Example

Table 1.0 illustrates an example of a certification having multiple sessions for a certification on “Becoming a Master Chef”.

TABLE 1.0
Certification Name: - “Becoming a Master Chef”

Session 1: Sauteeing, Grilling & Baking (Part 1)
Session 2: Sauteeing, Grilling & Baking (Part 2)
Session 3: Sauteeing, Grilling & Baking (Part 3)

Table 2.0 illustrates an example of tasks for the “Becoming a Master Chef” certification.

TABLE 2.0
Certification Name: “Becoming a Master Chef”

| | |
|---|---|
| Task Type: “Hands-On” | Task 1) Saute mushrooms for 2 hours |
| | Task 2) Grill for 2 hours |
| | Task 3) Bake for 2 hours |
| | Task 4) Wash dishes for 2 hours |

An apprentice may do the “Sauté” task (Task 1) in 30 minute increments and submit four time cards for this task. If all the timecards are approved by a supervisor, the apprentice has completed the “Sauté” task. In practice, each task will have some associated assignment that the apprentice must submit in order to complete the course. These assignments can be in the form of a quiz that the apprentice must complete including but not limited to a multiple choice test, numeric or text answers, and/or short answer (500 word style) responses. These assignments may also be a file the apprentice can upload to the system (e.g., image file and/or text document). Once assignments are completed, an instructor for this certification can review these assignments and approve or reject the apprentice's completion of this task.

### Certifier Interface

In another aspect, the Certifier Interface 100-2f, of the Web Interface Module 100-2 is another frontend application by which one or more certifications defined in a program are managed and approved by a certifier persona of the system 100. Once a certification is created by the program coordinator via the Program Coordinator Interface 100-2e, certifications are ready and must be approved by the certifier before that program is eligible for enrollment.

The Certifier Interface 100-2f may include a list of companies which is managed by the certifier, the number of pending approval certifications for the managed company, and the number of approved certifications for the managed company. In this interface, certifications are grouped by programs by which the certifier can select. Certifications must be approved at both the certification level and the task level. This means that each “course” task and each “hands-on” task must be inspected and approved, and once they are all approved the certification must be approved. A certification cannot be approved until all the associated tasks are approved.

The process of approving a certification generally requires:
1) Submitting a certification for approval by the program coordinator, freezing the certification and changing its status to “Pending Approval”.
2) Selecting the certification by the certifier for review and thereby changing its status to “Review Mode”.
3) In review mode, adding comments by the certifier on each task, allowing the certifier to submit the review.
4) After all tasks have been approved, completing approval submission and thereby changing its status to “Approved”. Alternatively, the certification is rejected.

The process of approving a task generally requires:
1) Selecting a certification by the certifier.
2) Navigating to “Course Tasks” or “Hands-On Tasks”.
3) Selecting each task.
4) Inspecting/Review each task.
5) Optionally providing feedback to the program coordinator for each task.
6) Approving or rejecting each task according to a set of predetermined requirements.

All inputs (selections, comments, and feedback) entered by the certifier in the Certifier Interface 100-2f are saved in the system, allowing the certifier to add, update, or delete existing inputs as needed.

### Instructor Interface

In another aspect, the Instructor Interface 100-2g, of the Web Interface Module 100-2 allows instructors to assist apprentices and help guide them through course tasks to successfully complete. As earlier presented, instructors are teachers that are assigned to teach certifications that are part of a specific program session, and certifications that belong to the specific program session will be referred herein as a certification session.

The Instructor Interface 100-2g may include selectable input components such as certification sessions that are assigned by instructor and grouped by program sessions. In the certification session, the Instructor Interface 100-2g presents all “Course Tasks” for that certification session where
1) Each task will display the number that is Pending Approval.
2) Instructor can select a task.
3) Each apprentice's request for task review is displayed.
4) A list of all other apprentices is displayed by which the instructor can select and add a message for that apprentice.
5) Apprentice's tasks are displayed and can be selected in order to a) view the assignment, quiz, lecture video, and any comments made by the Apprentice; and b) reply to Apprentice, or add a message by the instructor.
6) A global apprentice notes section is displayed by which the instructor can add a note available to all apprentices.

### Supervisor Interface

In another aspect, the Supervisor Interface 100-2h, of the Web Interface Module 100-2 allows supervisors to approve (or reject) an apprentice's performance on a “Hands-On” task. The Supervisor Interface 100-2h may include selectable input components such as a list of “Time Logs” submitted by apprentices of “Hands-On” tasks that the supervisor is assigned to oversee. From this list, the supervisor can approve or reject a time log submitted by the apprentice and leave a comment on a time log submission for feedback or follow up instructions for the apprentice.

### Contract Manager Interface

In yet another aspect, the Contract Manager Interface 100-2i, of the Web Interface Module 100-2 allows assignment of a supervisor to oversee an apprentice's performance on a “Hands-On” task for a specific day. The Contract Manager Interface 100-2i presents the user with multiple views and options, including but not limited to:
1) A view of a list of “Supervisor Requests”.
2) An option to make “Supervisor Requests” by apprentices for a supervisor for a particular day of performing a “Hands-On” task.
3) An option to select a supervisor Request for an apprentice.
4) An option to scroll through a list of available supervisors and select and assign them to that specific request. After assigning, the request will be sent to that supervisor for confirmation, at which point the supervisor must accept the assignment. Furthermore, after accepting, once the apprentice submits a time log for that particular task for that day, it will be sent to that assigned supervisor for approval.

### Apprentice Interface

In another aspect, the Apprentice Interface 100-2j, of the Web Interface Module 100-2 allows enrolled apprentices to access and manage their course work including but not limited to enrollment in new courses, viewing all certifications in a program in which they are enrolled, and submitting assignments for a course. As previously presented hereinabove, the apprentice is the persona that is enrolled in a program in order to develop career skills and participates in an apprenticeship program for a trade or profession via apprenticeship training courses that combines in-class instruction with practical hands-on experience.

The Apprentice Interface 100-2j provides the apprentice multiple views and options for the apprentice, including but not limited to:
1) A view of a list of all the certifications in the program in which they are enrolled.
2) A certification status showing which ones are completed, which ones are in progress, and which ones are not started.
3) An option to select a certification.
4) A view of a list of tasks for that certification having at least a section for “Hands-On” tasks and “Course” tasks.
5) An option to select a desired task to manage. In one instance, if it is a “Course” task, the apprentice can complete the task by submitting a course assignment, completing the course quiz, and/or watching the course video.
6) An option to be able to send a message to the instructor.
7) An option to be able to view and read messages left by the instructor.
8) An option to be able to view the status of a course task (e.g., Not submitted, Submitted, Approved, Rejected). If it is a “Hands-On” task, the apprentice can
a) Request a supervisor to be assigned, if one is not already assigned.
b) Clock-in.
c) Clock-out, which creates a new time log.
9) A view of a list of all time logs submitted for the task.
10) An option to select a desired task into a time log and view the status of it (e.g., Approved or Rejected).
11) An option to view comments left by supervisor.
12) An option to view the status of a Hands-On task (e.g., Not Started, In Progress, Completed)

In practice, apprentices can only be enrolled in one program session; not multiple programs. When the apprentice completes all the tasks in a certification, it must be double-approved by an instructor and a validator (or other appropriate approvers/reviewers as disclosed herein) before the apprentice is to receive any credit for the program in which they are enrolled.

Upon successful completion of the program, the apprentice is then identified as a program completer and is recognized, via certification, as competent in the occupational skill set for which they were trained. Advantageously, the system 100 may be applied to organizations and companies seeking to validate apprentice's completion of programs where, for example, the apprentice may receive federally recognized portable certification of their occupational training or any state licenses they completed as part of the program requirements. In addition, the system 100 can monitor, track, and correlate data of all apprentices for post training sector employment after course completion.

### Api Module

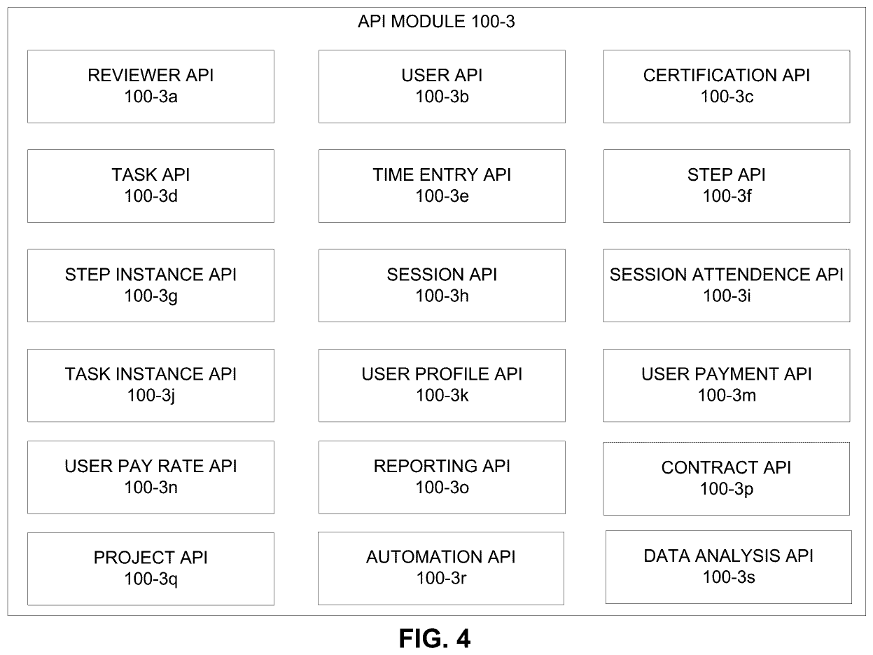

FIG. 4 illustrates the API Module 100-3 of the system 100 having application specific APIs for executing, performing, and managing apprenticeship programs, sessions, courses, and all other applications in the system 100, according to an embodiment. In practice, Application Programming Interfaces (APIs) are programmatically created to execute specific and routine tasks for these programs, sessions, and courses, allowing other applications in the system 100 to communicate with these APIs. For example, these programmable tasks may include a time entry application which calls an API via request parameters (e.g., employee's personal information and date range). When the API receives the requested parameters, it internally processes the request and returns all time entries associated with the employee for the given date range. In the API Module 100-3, the primary functional APIs in the system 100 may include but are not limited to a Reviewer API 100-3a, a User API 100-3b, a Certification API 100-3c, a Task API 100-3d, a Time Entry API 100-3e, a Step API 100-3f, an Step Instance API 100-3g, a Session API 100-3h, a Session Attendance API 100-3i, a Task Instance API 100-3j, a User Profile API 100-3k, a User Payment API 100-3m, a User Pay Rate API 100-3n, a Reporting API 100-30, a Contracts API 100-3p, a Project API 100-3q, an Automation API 100-3r, and a Data Analysis API 100-3s.

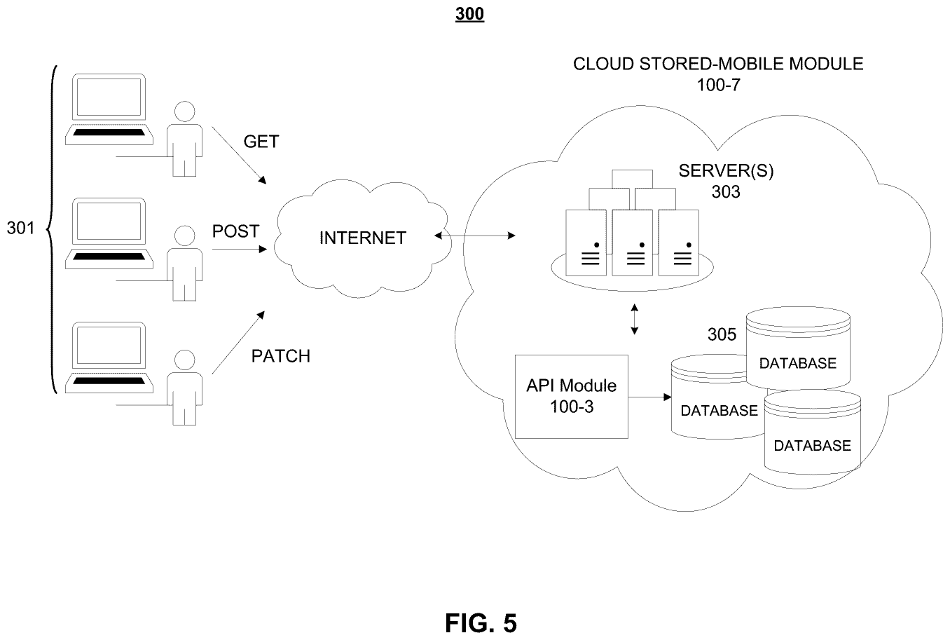

FIG. 5 illustrates computer system architecture 300 where data is communicated between clients 301 and a cloud server 303 over a public network (e.g. Internet). API defines the communication structure and methods that allow clients the ability to access applications and information on the server's local or remote databases 305. In one aspect, the API may act as a gateway between clients and resources from the cloud server over the Internet. Clients can be one or more users or automated computing systems that use the API for accessing information such as weather, financial, or news data from the server. Resources include any digital content that is communicated to clients who are making the request and may include images, videos, text, numbers, or any type of data.

In one application, requests by clients are sent to the cloud server using HTTP requests. Request headers of HTTP request are the metadata exchanged between the client and server. When an HTTP request to the server is initiated by the client, the API queries the database(s) based on the request and then sends back a response to the client. These responses may be formatted in JSON, XML, or other data serialization formats. These requests (or calls) to the APIs may be handled via GET/POST/PUT/PATCH/DELETE commands. For example, calls made by the HTTP GET request methods read from the server's database retrieving requested resources. Calls made by the HTTP POST methods create resources (i.e., files) in the database of the server. Calls made by the HTTP PUT methods update rows by replacing their content in the database of the server. Calls made by the HTTP PATCH methods update rows by modifying their content in the database of the server. Calls made by the HTTP DELETE methods delete rows in the database of the server. APIs utilizes a schema having metadata about how data is structured, allowing users to interact with the API and its endpoints. Schemas types may include but are not limited to JSON and OPEN API schemas. For example, the contents of a JSON object structure may have zero, one, or more key-value pairs, also called properties. The object is enclosed by curly braces while all key-value pair is separated by a comma. In terms of syntax, the key-value pair may include a key and a value, separated by a colon, the key is a string, which identifies the key-value pair, and the value can be any of the data types, including string, number, float, array, object, Boolean, or empty.

Calls initiated by clients to the server 303 may include built-in security protocols and authentication measures preventing unauthorized access to private data. For example, some HTTP authentication schemes include basic authentication, bearer authentication, API keys, and OAuth. User name and password are transmitted by the client in the request header during basic authentication. Base64 is an encoding method that turns the pair into a collection of 64 characters for secure transmission. Giving the token bearer access control is referred to as bearer authentication. The server normally generates the bearer token in response to a login request. It is typically an encrypted string of characters. To access resources, the client includes the token in the request headers.

The use of API keys is another authentication scheme in which the server gives a brand-new client a special created value. The client uses the special API key to identify itself each time it wants to access resources. Because the client must send the key, which leaves it open to network attack and theft, API keys are less secure.

Secure login access to any system may also employ OAuth which combines passwords and tokens. The authorization procedure is completed by the server after it first requests a password and an extra token. It has a defined scope and lifespan and may verify the token at any moment as well as over time.

Referring again to FIG. 4, each API may have its own unique resource identifiers allowing clients to access specific content associated with each API (100-3a through 100-3s) for handling modes of operations within the system 100. These modes of operations are configured to perform various functions for handling all apprentices, course assignments, persona management functions, course tasks, time entries, course programs, program sessions, and other apprentice resources in the system 100.

The Reviewer API 100-3a handles and processes all data exchanges of Reviewers 100-1b and Validators 100-1c in the system 100 via POST and GET Requests to the server 303, according to an embodiment. Reviewers are assigned to validators via POST requests while a list of reviewers is compiled and accessible via GET requests. In one aspect, the Reviewer API 100-3a may employ and assign validator ID and reviewer ID for all POST transactions. In another aspect, the Reviewer API 100-3a manages both validator approvals of what the reviewer approves and reviews by reviewers of all apprenticeship tasks.

The User API 100-3b manages all user operations, including but not limited to login procedures, new user creation methods, user role granting, and methods for generating companies for users in the system 100, according to an embodiment. In one aspect, the user operations in the User API 100-3b may utilize and assign fields (e.g., login_name, passcode_ID, first_name, last_name, session_ID, and attendee_ID) for all POST or PATCH transactions.

The Certification API 100-3c manages all certification creations, updates, rejections, approvals, and data retrievals by employing POST/GET/PATCH methods in the system 100, according to an embodiment. An example of the object structure for creating certifications in the Certification API 100-3c is shown in Table 3.0.

TABLE 3.0

```
  “name”: “Plumbing Certification”,
  “summary”: “learn to use Plumbing as pro”,
  “goals”: [
    “create Plumbing account”,
    “setup IAM”,
    “create applications”,
    “deploy applications”
  ],
  “companyId”: “1”,
  “creatorId”: “2”,
“comment”: “certification for Plumbing”
```

An example of the object structure for updating certifications in the Certification API 100-3c is shown in Table 4.0.

TABLE 4.0

```
{
  “id”: “9229d2ee-6dc3-43ba-a402-fcea8bc6bed5”,
  “updaterId”: “3”,
  “name”: “ Plumbing Certification - A Primer”,
  “summary”: “learn to use Plumbing as a pro”,
  “comment”: “updating Plumbing Certification again ”
}
```

An example of the object structure for rejecting certifications in the Certification API 100-3c is shown in Table 5.0.

TABLE 5.0

```
{
  “id”: “f92c0f1b-54c4-4620-8d3f-e8eeb4b09c77”,
  “updaterId”: “2”
  “comment”: “rejected”
}
```

An example of the object structure for approving certifications in the Certification API 100-3c is shown in Table 6.0.

TABLE 6.0

```
{
  “id”: “631dea38-3a85-469d-af3e-f6b8265e635a”,
  “updaterId”: “2”,
  “comment”: “approved”
}
```

The Task API 100-3d manages all task creations and updates via POST/PATCH methods in the system 100, according to an embodiment. An example of the object structure for creating tasks in the Task API 100-3d is shown in Table 7.0.

TABLE 7.0

```
{
  “name”: “Learn to create Welder Account”,
  “type”: “GOAL”,
  “description”: “learn to how to create an Welder account”,
  “certificationId”: “1”,
  “taskGoal”: “test”,
  “additionalInfo”: {
    “totalMinutesToCompletion”: 120
  },
  “userId”: “1”,
  “steps”: [ ]
}
```

An example of the object structure for updating tasks in the Task API 100-3d is shown in Table 8.0.

TABLE 8.0

```
{
  “id”: “278c4e51-c78f-4860-977f-eb2faf37ec61”,
  “name”: “Learn to create Welder Account”,
  “description”: “learn to how to create an Welder account,
V2”,
  “userId”: “1”
}
```

The Time Entry API 100-3e manages all time logs entered by the apprentice, including but not limited to time-entry creations, updates, approvals, reviews, resubmissions, validator rejections, and reviewer rejections by employing POST/PATCH methods in the system 100, according to an embodiment. An 10 example of the object structure for creating time entries in the Time Entry API 100-3e is shown in Table 9.0.

TABLE 9.0

```
{
  “taskInstanceId”: “3”,
  “approverId”: “1”,
  “startTime”: “2023-02-09 12:00:00 UTC”,
  “endTime”: “2023-02-09 13:00:00 UTC”
}
```

An example of the object structure for updating time entries in the Time Entry API 100-3e is shown in Table 10.0.

TABLE 10.0

```
{
  “id”: “1e63c78a-399a-4a11-ad9e-dfba688f6f9e”,
  “status”: “REJECTED”,
  “comment”: “resubmitting time”,
  “startTime”: “2023-02-09 09:00:00 UTC”,
  “endTime”: “2023-02-09 13:00:00 UTC”
}
```

An example of the object structure for approving time entries in the Time Entry API 100-3e is shown in Table 11.0.

TABLE 11.0

```
{
  “id”: “1”,
  “comment”: “great job, approved”,
  “submitterId”: “1”
}
```

An example of the object structure for reviewing time entries in the Time Entry API 100-3e is shown in Table 12.0.

TABLE 12.0

```
{
  “id”: “cd717e49-a8a6-49c5-b902-ae903d06cca5”,
  “comment”: “rejecting, hours are wrong”,
  “submitterId”: “1”,
  “startTime”: “2023-02-09 09:02:00 UTC”,
  “endTime”: “2023-02-09 12:00:03 UTC”
}
```

An example of the object structure for resubmitting time entries in the Time Entry API 100-3o is shown in Table 13.0.

TABLE 13.0

```
{
  “id”: “1”,
  “comment”: “fixing hours again”,
  “submitterId”: “2”,
  “startTime”: “2023-02-09 11:00:00 UTC”,
  “endTime”: “2023-02-09 13:00:00 UTC”
}
```

An example of the object structure for the validator rejecting time entries in the Time Entry API 100-3o is shown in Table 14.0.

TABLE 14.0

```
{
  “id”: “1”,
  “comment”: “rejecting, hours are wrong”,
  “submitterId”: “3”
}
```

An example of the object structure for the reviewer rejecting time entries in the Time Entry API 100-3e is shown in Table 15.0.

TABLE 15.0

```
{
  “id”: “1”,
  “comment”: “rejecting, hours are wrong”,
  “submitterId”: “2”,
  “startTime”: “2023-02-09 10:00:00 UTC”,
  “endTime”: “2023-02-09 12:00:00 UTC”
}
```

The Step API 100-3f manages all step (or task) creations and updates by employing POST/PATCH methods in the system 100, according to an embodiment. An example of the object structure for creating step entries in the Step API 100-3f is shown in Table 16.0.

TABLE 16.0

```
{
  “taskId”: “278c4e51-c78f-4860-977f-eb2faf37ec61”,
  “name”: “build applications in Web Programming account”,
  “description”: “learn how to build a simple web app in HTML”,
  “userId”: “1”
}
```

An example of the object structure for updating step description entries in the Step API 100-3f is shown in Table 17.0.

TABLE 17.0

```
{
  “id”: “dea0155b-d747-494b-9ecc-8ef25ece8674”,
  “name”: “build applications in Web Programming account”,
  “description”: “learn how to build all applications in HTML”
  “userId”: “1”
}
```

The Step Instance API 100-3g manages all step instances updates, reviews, approvals, rejections by reviewers, rejections by validators, and submission, employing PATCH methods in the system 100, according to an embodiment. An example of the object structure for updating step instances in the Step Instance API 100-3g is shown in Table 18.0.

TABLE 18.0

```
{
  “id”: “0cc6f47e-cd3e-4cab-b2e3-f78d3f24455a”,
  “status”: “IN_PROGRESS”
}
```

An example of the object structure for reviewing step instances in the Step Instance API 100-3g is shown in Table 19.0.

TABLE 19.0

```
{
  “stepInstanceId”: “2”,
  “submitterId”: “2”,
  “comment”: “reviewed”
}
```

An example of the object structure for approving step instances in the Step Instance API 100-3g is shown in Table 20.0.

TABLE 20.0

```
{
  “stepInstanceId”: “2”,
  “submitterId”: “3”,
  “comment”: “looks good - final approval”
}
```

An example of the object structure for reviewer rejecting step instances in the Step Instance API 100-3g is shown in Table 21.0.

TABLE 21.0

```
{
  “stepInstanceId”: “2”,
  “submitterId”: “2”,
  “comment”: “I dont like it”
}
```

An example of the object structure for the validator rejecting step instances in the Step Instance API 100-3g is shown in Table 22.0.

TABLE 22.0

```
{
  “stepInstanceId”: “2”,
  “submitterId”: “3”,
  “comment”: “I dont like it”
}
```

An example of the object structure for submission step instances in the Step Instance API 100-3g is shown in Table 23.0.

TABLE 23.0

```
{
  “stepInstanceId”: “2”,
  “approverId”: “2”,
  “submitterId”: “1”,
  “comment”: “resubmitting again”
}
```

The Session API 100-3h manages all session creations and data retrievals by employing POST/GET methods in the system 100, according to an embodiment. An example of the object structure for creating sessions in the Session API 100-3h is shown in Table 24.0.

TABLE 24.0

```
{
  “name”: “AWS Certification - Session 1”,
  “startTime”: “2022-03-01”,
  “endTime”: “2023-03-01”,
  “certification”: {
    “id”: “2d180f87-3f28-4b5d-b28a-76a619e43546”
  }
}
```

Session data may be retrieved via GET methods, including but not limited to sessions for user, applicants in session, users in session, task data for approval, and session for certification ID.

The Session Attendance API 100-3i handles and processes all session attendance creations and data retrievals by employing POST/GET methods in the system 100, according to an embodiment. An example of the object structure for creating session attendances in the Session Attendance API 100-31 is shown in Table 25.0.

TABLE 25.0

```
{
  “sessionId”: “c1eeffab-2549-43a4-8151-824b54706225”,
  “attendeeId”: “3”
}
```

Session attendance data may be retrieved via GET methods which include but are not limited to task instances for session attendance.

The Task Instance API 100-3j handles and processes all task update instances and data retrievals by employing PATCH/GET methods in the system 100, according to an embodiment. An example of the object structure for updating task instances in the Task Instance API 100-3j is shown in Table 26.0.

TABLE 26.0

```
{
  “id”: “0fff25ec-8c80-4bc1-8447-57e9ee0a1fa7”,
  “additionalInfo”: {
    “note”: “very well done”,
    “timestamp”: “2022-02-03”
  },
  “approverId”: “2”,
  “completionTime”: “2022-02-03”
}
```

Task instance data may be retrieved via GET methods which may include but are not limited to step instances and task entries.

The User Profile API 100-3k manages all user profile creation, updates, and data retrievals by employing POST/PATCH/GET methods in the system 100, according to an embodiment. An example of the object structure for creating user profiles in the User Profile API 100-3k is shown in Table 27.0.

TABLE 27.0

```
{
  “userId”: “1”,
  “name”: “Diksha Upmanyu”,
  “age”: “28”,
  “gender”: “female”,
  “designation”: “senior software engineer”,
  “companyId”: “1”,
  “hourlyRate”: “200”,
  “description”: “testdescription”,
  “ethincity”: “ASIAN”,
  “educationLevel”: “HIGH_SCHOOL”,
  “income”: “5000”,
  “employmentType”: “FullTime”,
  “employmentIndustryId”: “FINANCIAL ACTIVITES”,
  “martialStatus”: “Unmarried”,
  “sexualOrientation”: “NA”,
  “religion”: “Indian”,
  “geographyId”: “SOUTH AMERICA”,
  “citizenshipStatus”: “Yes”,
  “languageSpoken”: “English”,
  “retirementStatus”: “No”,
  “disabilityStatus”: “No”,
  “militaryServiceStatus”: “No”
}
```

An example of the object structure for updating user profiles in the User Profile API 100-3k is shown in Table 28.0.

TABLE 28.0

```
{
  “id”: “1”,
  “userId”: “1”,
  “name”: “Diksha”,
  “age”: “28”,
  “gender”: “FEMALE”,
  “occupation”: “Software Engineer”,
  “hourlyRate”: “10”,
  “description”: “test”,
  “ethincity”: “AMERICAN INDIAN OR ALASKA NATIVE”,
  “educationalLevel”: “BACHELOR”,
  “income”: “5000”,
  “employmentType”: “FULL TIME”,
  “position”: “Senior”,
  “employmentIndustryId”: “EDUCATIONAL SERVICES”,
  “maritalStatus”: “MARRIED”,
  “sexualOrientation”: “STRAIGHT”,
  “religion”: “BUDDHISM”,
  “geographyId”: “AFRICA”,
  “citizenshipStatus”: “AMERICAN CITIZENSHIP”,
  “languageSpoken”: “ENGLISH”,
  “retirementStatus”: “NON RETIRED”,
  “disabilityStatus”: “NOT DISABLED”,
  “militaryServiceStatus”: “ACTIVE DUTY”
}
```

Once a user profile is created and available in the system 100 contents in the user profile may be queried and then retrieved via GET methods.

The User Payment API 100-3m handles and processes all user payment creation, updates, and data retrievals by employing POST/PATCH/GET methods in the system 100, according to an embodiment. An example of the object structure for creating user payments in the User Payment API 100-3m is shown in Table 29.0.

TABLE 29.0

```
{
  “userId”: “1”,
  “taskId”: “1”,
  “startDate”: “01/12/2024”,
  “endDate”: “10/12/2024”,
  “position”: “Plumber”,
  “payeeCompany”: “Dell”,
  “level”: “Junior”,
  “source”: “SELF”,
  “hourlyRate”: 10,
  “minutes”: 30
}
```

An example of the object structure for updating user payments in the User Payment API 100-3m is shown in Table 30.0.

TABLE 30.0

```
{
  “id”: “125b5dc2-6e0a-4a0e-aa3d-e36661d306ac”,
  “userId”: “1”,
  “taskId”: “1”,
  “startDate”: “01/12/2023”
  “endDate”: “10/12/2023”,
  “position”: “Plumber”,
  “payeeCompany”: “Dell”,
  “level”: “Junior”,
  “hourlyRate”: 12,
  “hours”: 4,
  “minutes”: 10
}
```

Upon creation of the user payment in the system 100, contents in the user payment may be queried and then retrieved via GET methods.

The User Pay Rate API 100-3n manages all user pay rate creation, updates, and data retrievals by employing POST/PATCH/GET methods in the system 100, according to an embodiment. An example of the object structure for creating user pay rates in the User Pay Rate API 100-3n is shown in Table 31.0.

TABLE 31.0

```
{
  “userId”: “1”,
  “startDate”: “01/12/2023”,
  “endDate”: “01/12/2023”,
  “position”: “Handyman”,
  “level”: “Junior”,
  “type”: “Self”,
  “recordedDate”: “01/12/2023”,
  “hourlyRate”: 10
}
```

An example of the object structure for updating user pay rates in the User Pay Rate API 100-3n is shown in Table 32.0.

TABLE 32.0

```
{
  “id”: “54cf3fcd-ee02-4674-89d3-8c9c3cf2ea1a”,
  “startDate”: “01/12/2023”,
  “endDate”: “05/12/2023”,
  “position”: “Handyman”,
  “level”: “Junior”,
  “type”: “Self”,
  “recordedDate”: “01/08/2023”,
  “hourlyRate”: 10
}
```

Upon creation of the user payment in the system 100, contents in the user payment may be queried and then retrieved via GET methods.

The Reporting API 100-3o is responsible for providing a standardized reporting mechanism for platform independent applications supporting both pre-defined and customized reporting formats. The Reporting API 100-3o may include a set of functions and procedures (call and event-based routines) for accessing the data from table resources 400 and features of other modules and applications in the system 100 which facilitate all user report generation.

The Contracts API 100-3p is responsible for supporting all contract functions and applications in the Contract compliance Module 100-8 of the system 100, according to an embodiment. The Contracts API 100-3p may include a set of functions and procedures (call and event-based routines) for accessing the data from table resources 400 (e.g., contracts table 400-11 and contractComponents table 400-23) as well as features from other modules and applications in the system 100 which support all contract handling.

The Project API 100-3q is responsible for supporting all project management functions and applications in the system 100, according to an embodiment. The Project API 100-3q may have a set of functions and procedures (call and event-based routines) for accessing the data from table resources 400 (e.g., projects table 400-17) and features from other modules and applications in the system 100 for handling all project matters.

The Automation API 100-3r is responsible for supporting all automation functions and applications in the system 100, according to an embodiment. The Automation API 100-3r may have a set of functions and procedures (call and event-based routines) for accessing the data from table resources 400 and features from other modules and applications in the system 100 for handling all automated processing events.

The Data Analysis API 100-3s is responsible for supporting all analysis functions and applications in the system 100, according to an embodiment. The Data Analysis SAPI 100-3s may have a set of functions and procedures (call and event-based routines) for accessing the data from table resources 400 and features from other modules and applications in the system 100 for determining and calculating predetermined system-related metrics, including but not limited to financial metrics, training metrics, performance metrics, user metrics, system metrics, predictive metrics, and so on.

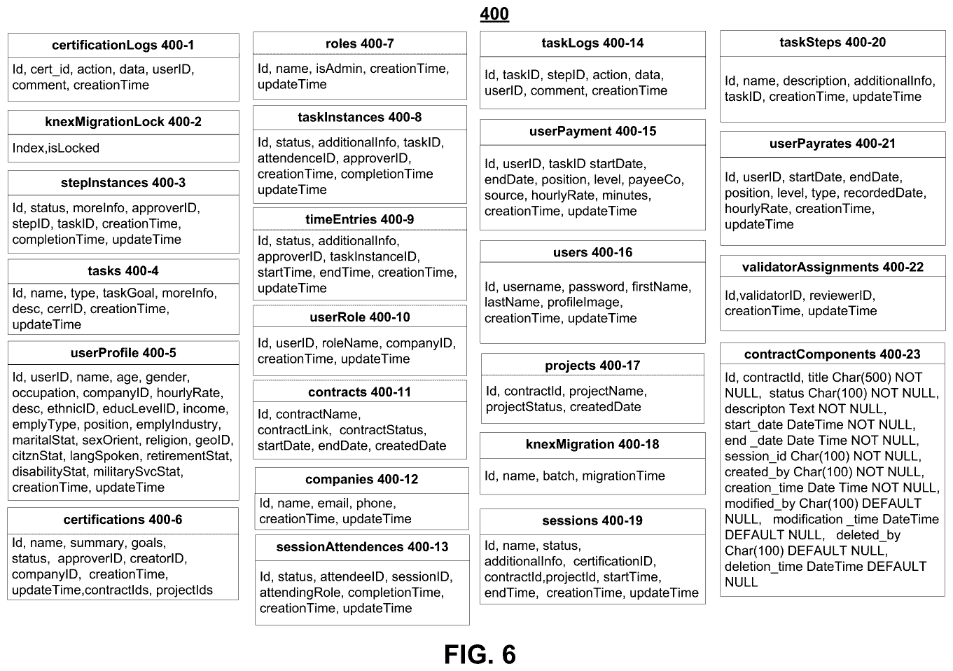

FIG. 6 illustrates a schema of table resources 400 (database objects) utilized by APIs and other system modules in the system 100, according to an embodiment. Table resources may be grouped into categories for defining data components related to system, user, training, certification, contract, task, payment, session, and project information. For example the certificationLogs table 400-1 defines data components for all certification logs information such as id, cert id, action, and so on. The knexMigrationLock table 400-2 defines data components for preventing multiple processes from running the same migration batch at the same time from multiple clients. The stepInstances table 400-3 defines all data components for all program steps provided in the system 100. The task table 400-4 defines data components which are managed by the task API 100-3d for handling all physical assignments or course information provided by the system 100. The userProfie table 400-5 defines data components which are managed by the user API 100-3b for tracking all users enrolled in the system 100. The certification table 400-6 defines data components which are managed by the certification API 100-3c for tracking all certification programs in the system 100. The roles table 400-7 defines data components for all administrator role types in the system 100. The taskInstances table 400-8 defines data components which are managed by the task instance API 100-3j for all task activities in the system 100. The timeEntries table 400-9 defines data components for which are managed by the time entry API 100-3e tracking task times in the system 100. The userRoles table 400-10 defines data components which are managed by the user profile API 100-3k for tracking other user roles in the system 100. The contracts table 400-11 defines data components which are managed by the contract API 100-3p for tracking all contract information in the system 100. The companies table 400-12 defines data components which are managed by the user profile API 100-3k and certification API 100-3c for tracking all companies participating in the system 100. The sessionAttendences table 400-13 defines data components for managing and tracking all sessions taken by attendees in the system 100. The taskLogs table 400-14 defines data components which are managed by the user task API 100-3d for managing and tracking all tasks completed by participants of the system 100. The userPayment table 400-15 defines data components which are managed by the user payment API 100-3m for all payment information of users in the system 100. The users table 400-16 defines data components for all login user information of participants in the system 100. The projects table 400-17 defines data components for all project information in the system 100. The knexMigrations table 400-18 defines data components for tracking and managing all migration events in the system 100. The sessions table 400-19 defines data components which are managed by the session API 100-3h for tracking and managing all session events in the system 100. The taskSteps table 400-20 defines data components of all task descriptions which are managed by the task API 100-3d in the system 100. The userPayrate table 400-21 defines data components which are managed by the user pay rate API 100-3n for tracking and managing all user pay rates in the system 100. The validatorAssignments table 400-22 defines data components of assignments which are managed by the reviewer API 100-3a or certification API 100-3c for tracking all validator assignment in the system 100. The contractComponents table 400-23 defines data components of assignments which are managed by contract API module 100-3p for tracking all ancillary contract data in the system 100.

Each table resource may include one or more data components having unique field identifiers for storing object data of various data types. For example, field identifiers associated with the “certifications” table may include Id, name, summary, goals, status, approverID, creatorID, companyID, creationTime, updateTime, contractIds, and projectIds. Field identifiers may share the same name across multiple tables allowing these tables to store, associate, and search corresponding records by their common field name (e.g., Id, username, etc.). Tables and field identifiers can be accessed by the other modules (100-1 to 100-8) for generating reporting metrics, determining current status of users, calculating financial and ROI metrics, calculating performance metrics, determining system usage rates, analyzing apprenticeship metrics and so on.

### Reporting Module

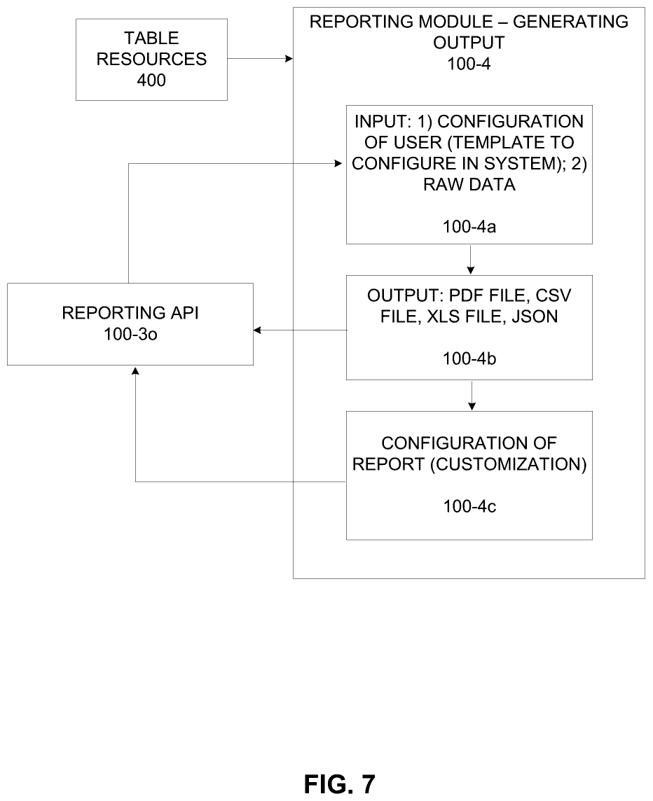

FIG. 7 illustrates Reporting Module 100-4 of the system 100, according to an embodiment. Reporting Module 100-4 is responsible for generating and managing all reports in the system 100, including but not limited to ROI reports, apprenticeship performance reports, financial reports, system usage reports, according to an embodiment. In one aspect, reports may be created by the Reporting Module 100-4 based on source data acquired from one or more database objects stored in one or more tables from the list of table resources 400. In another aspect, the Reporting Module 100-4 may receive as input from the Reporting API 100-3o user configured templates and/or raw data inputs 100-4a from which an array of comprehensive report formats and styles may be generated, transmitted, or stored in the system 100. At the output side 100-4b of the Reporting Module 100-4, supported report generated format types may include but are not limited to PDF, CSV, XLS, and JSON. In yet another aspect, the Reporting Module 100-4 may be configured to support pre-defined reporting templates or customized reporting templates 100-4c by which users may create their own report format, data fields, tables, and graphs contained therein.

### Automation Module

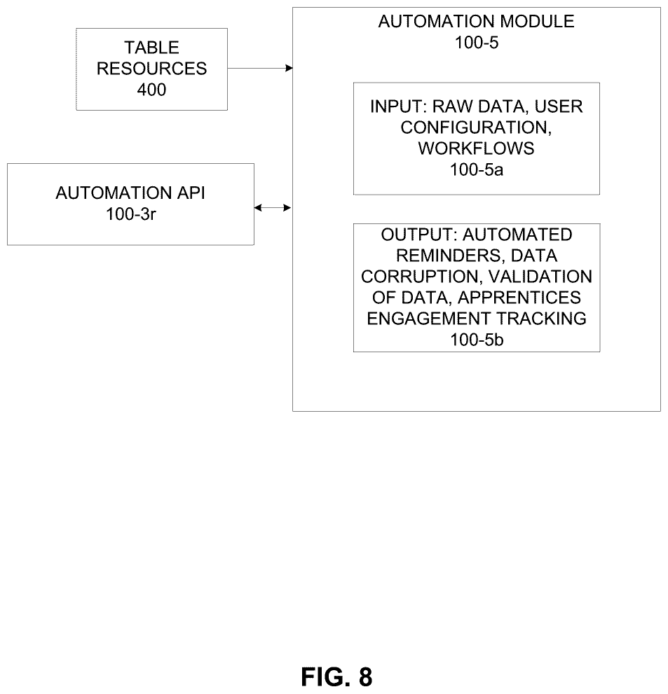

FIG. 8 illustrates Automation Module 100-5 of system 100, according to an embodiment. Automation Module 100-5 provides the system 100 a resource by which automated tasks and control are possible via predefined syntax commands to conduct automated updates, additions, and verification of data to and from other modules. Requests may be submitted to the Automation Module 100-5 via the Automation API 100-3r for performing one or more automated operations. Advantageously, automated commands may increase system performance and can be easily performed on multiple modules or in the entire system 100. Inputs 100-5a to the Automation Module 100-5 may include, for example, raw data as received from the table resources 400, configuration settings, and workflow settings. In response to submitted requests, an output 100-5b of the Automation Module 100-5 may include, for example, setting automated reminders, detecting and setting auto alerts for data corruption events, automatically testing for validation of data, and auto-tracking apprentice engagement.

### Data Analysis Module

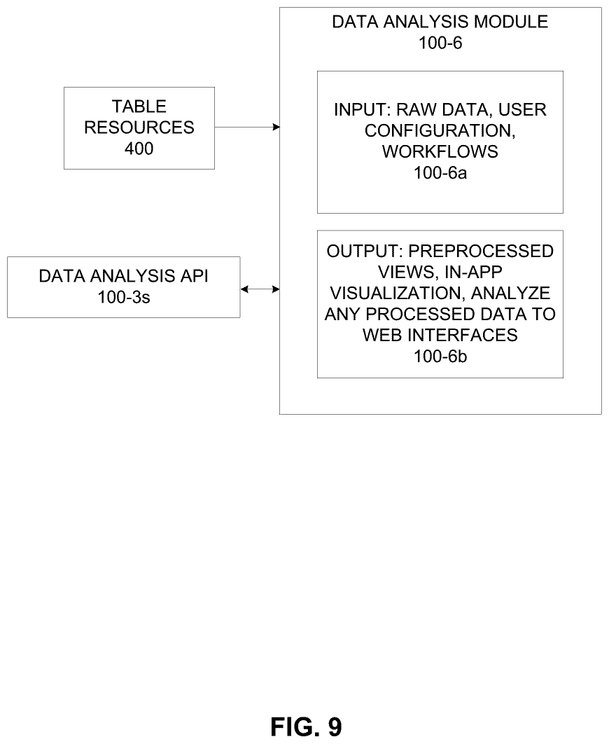

FIG. 9 illustrates Data Analysis Module 100-6 of system 100, according to an embodiment. The Data Analysis Module 100-6 is responsible for performing functions that sift, process, and determine meaningful information in targeted data sets to discover, interpret, and share new insights and knowledge from the data sets. In one aspect, the analyzed data is pre-processed and analyzed beforehand to find patterns of features such as drop rates in attendance, performance rates of apprenticeship, popularity of courses and programs, and so on.

The Data Analysis Module 100-6 may support both data analytic models for general reporting (i.e., counting numbers of people in a program, types of job types, and service workers) and data analytic models for analyzing the behavior of people (i.e., people's course interests, entry tracking; success of program's app usage by people). The Data Analysis Module 100-6 as a whole may also determine patterns, graduations, and success rates of apprentices. For example, an analyst persona using this module is able to calculate the performance of all participants and level of performance data thereof based on pertinent raw data in the system 100, calculating metrics of financial success rates and return on investment (ROI) numbers. Inputs 100-6a to the Data Analysis Module 100-6 may include, for example, raw data as received from the table resources 400, configuration settings, and workflow settings. In response to submitted requests, an output 100-6b of the Data Analysis Module 100-6 may include, for example, output 100-6b including preprocessed views, in-app visualization, and analysis of any processed data to web interfaces.

### Cloud Stored-Mobile Module

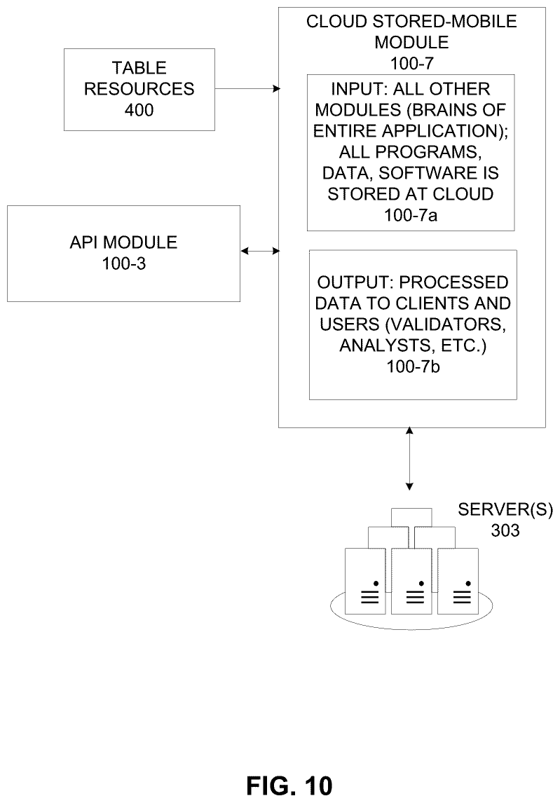

FIG. 10 illustrates the Cloud Stored-Mobile Module 100-7 of system 100, according to an embodiment. The Cloud Stored-Mobile Module 100-7 is responsible for handling all file synchronization, storage, and backup services providing seamless access between the other modules in the system 100 and all remote servers 303 hosting the file repositories and databases of the system 100. Data from API module 100-3 and table resources 400 may be hosted in the remote servers 303 whereby data transfer between the system 100 and the remote servers 303 are handled by the Cloud Stored-Mobile Module 100-7. Inputs 100-7a may include, for example, raw data as received from the table resources 400, raw data from all other modules, all programs, and application data. In response to submitted requests, an output 100-7b of the Cloud Stored-Mobile Module 100-7 may include, for example, processed and raw data to clients and end users (validators, analysts, certifiers, etc.).

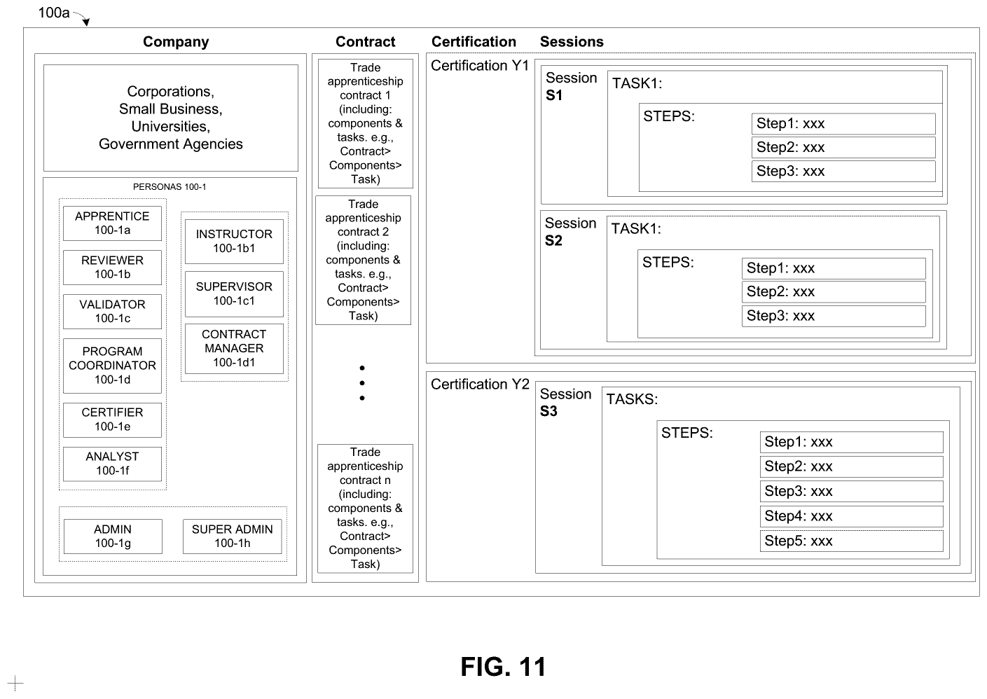

FIG. 11 illustrates an implementation of the system 100 as a workforce training model 100a, according in an embodiment. In one aspect, the system 100 allows one or more companies (e.g., corporations, small businesses, universities, or government agencies) to define, assign, and manage their own unique personas via the personas module 100-1. In another aspect, the system 100 also allows the company to record, manage, and track one or more contracts (e.g., trade apprenticeship contracts 1, 2, . . . , n) procured by the company from federal, state, or independent agencies who define and establish the requirements for all contractors (e.g., apprentices) as part of the conditions awarded in the contract. These contracts may be linked to one or more course certifications (Y1, Y2 and so on) made up of at least one session (S1, S2, . . . . Sn). In operation, an apprentice enrolled in a course for a given certification may perform and submit tasks and steps to complete the certification process. Once certifications are completed, the reviewer is responsible for verifying and insuring all tasks submitted by the apprentice are correct while the validator is responsible for insuring all work by the reviewer is correct and properly handled. In this instance, one role of the validator is to perform a quality assurance (QA) check of the reviewer, effectively performing a two-step validation process of all submissions in a course certification. This two-step validation may be performed multiple times for all course certifications insuring that the submitted task data from the apprentice is accurate and error free. The company may designate and assign a program coordinator who is responsible for overseeing and managing digital content, personnel, and notifications of the system 100.

### Contract Compliance Module

In the system 100, the workforce training model 100a is configured to operate and communicate with the contract compliance module 100-8 in real-time, handling and managing ROI matters related to apprenticeship training, project compliance reporting, and data aggregation of information acquired from performance management systems outside of the system including, for example, remote and/or disparate service models.

The system pipeline generally moves from the workforce training model 100a which handles job readiness training to formal training/training to enhance occupational competencies that combine technical instruction with on-the-job training, as part of an apprenticeship or professional development programs, to the contract compliance module 100-8 which executes contract performance management where employer data tracking is correlated to wages earned over time and training delivery captured by the workforce training component 100a of the system 100. Advantageously, the contract compliance module 100-8 can be dynamically reconfigured for multiple reporting purposes in a single stream of compliance tracking, including over specific time periods.

### Contract Compliance Management Tracking

The contract compliance module 100-8 may interact with a contracts database for storing all the data reporting elements and transactions of all procurement engagements of goods, services, and works originating from federal, state, or private entities. In some aspects, the system 100 and modules therein may act as a data aggregator to capture information from multiple sources including payroll, training, contract management and similar information and reconfigure the aggregated data to customize reporting output for end users.

The contract is the principle instrument for laying out what the requirements are that would make the engagement successful by connecting the overall contract performance to individual performance tracking and allowing for ROI calculations and real-time contract compliance performance validation via the Data Analysis Module 100-6. Advantageously, the system 100 provides live and real-time contract compliance ROI results, unlike other manually based compliance systems that are only capable of providing time-delayed ROI results based on post-performance data which often requires several months to analyze and formulate.

### Return on Investment (ROI)

Return on investment (ROI) is a key financial tool and metric used to determine the profitability and performance of an investment made by one or more investors or stakeholders. In general, simple ROI calculations can be calculated by dividing the total profit from an investment by the initial cost of the investment, and then multiplying it by 100 to get a percentage as shown in equation EQ. 1.

$$ROI ( in percent ) = ( Total Profit / Investment Cost ) * 100 \qquad ( EQ . 1 )$$

ROI can provide key insights into the performance or success of an investment made by the stakeholders where a high ROI may indicate successful investment strategies and performance outcomes, while a low ROI may suggest poor and likely undesirable strategies and performance outcomes.

In one instance, an ROI Indicator may be partly based on algorithms and/or correlation data analysis performed by the Data Analysis Module 100-6, allowing stakeholders and users of the system 100 to assess the performance of different programs and projects therein.

### ROI Framework

A quality framework for ROI calculation in the system 100 may include:
1. Having Clear Objectives: The intelligent Validation platform is designed to meet customized Key Performance Indicators (KPI's) based on the user's design needs and structures, typically aligned to HR policy. This helps ensure clear understanding of the objective of the ROI calculation, including the scope and context of the investment.
2. Performing Accurate Methods of Data Collection: The system aggregates and allows for the validation of accurate and relevant data to ensure that the ROI calculation reflects the real-world situation as closely as possible.
3. Determining All Costs and Returns: The system factors in all relevant costs (both direct and indirect) and returns when calculating ROI to get a comprehensive view of the investment's performance while tracking over time. This includes, for example, time to delivery (the time from completion of training to new or expanded business capture).
4. Applying Consistent Metrics: Ensuring consistency in the metrics and parameters used, particularly when comparing the ROI of different investments.
5. Comparing with Benchmarks: The system can allow users to compare ROI with internal or industry benchmarks or alternative investments to determine relative performance.
6. Performing Post-Investment Analysis: After the investment period, the system can support a post-investment analysis to compare projected ROI with actual ROI, and understand the variations.
7. Supporting Documentation and Communication: Document the process, assumptions, and results clearly, and generate reporting for relevant stakeholders.
8. Performing Continuous Monitoring: Continuously monitors and, if necessary, allows for adjustment of the investment strategy based on ongoing ROI analyses and changing circumstances.

### ROI Indicator Calculation and Baseline Value

In order to ensure quality framework for ROI calculation, key factors captured by system 100 may be used to determine the ROI indicator, including but not limited to:
1. Employee Retention for tracking all improvements in employee retention rates and reduced turnover, which can be costly.
2. Increased Sales or Revenue for evaluating any direct increase in sales, customer acquisition, or upselling that may be attributed to enhanced skills from training.

### ROI Indicator Calculation

In the system 100, the ROI indicator may be determined based on total net benefit factors and total cost factor as shown in Eq. 2 below.

$$ROI Indicator = ( Net Benefits / Total Costs ) \times 100 \% \qquad ( Eq . 2 )$$

where, Net Benefits is equal to the Total Benefits-Total Costs, and the Total Costs is equal to the Sum of all direct and indirect costs associated with the training provided in the system 100.

### ROI Indicator Calculation Example: Corporate Training

In one non-limiting instance, the ROI Indicator may be applied in a corporate training scenario using Eq. 2 as follows:

Net Benefits=Value generated by employee after training−Total Cost of Training; Net Benefits=employee post training portfolio value measured over time−Pre-Training value of client portfolio (responsibility); Net Benefits=difference in pre-training portfolio and employee portfolio at 6 months after training. If $100,000 was invested in client contracts pre-training, and $130,000 was generated in client contracts 6 months after training, the Net Benefits=$30,000 for that 6 months, or $5,000 per month.

Total Cost=employee salary cost away from normal work performance+the cost of training (including all cost e.g. instructor, material, certification, etc.)=Total Cost of Training=number of hours (Salaried employee making $30 per hour−example: 20 hours per week for 4 weeks)+ (example fixed cost of training $1500)=$2400 (8 hours at $30 per hour)+$1500 (sample total training cost)=$3900 per month or four weeks.

$$ROI Indicator = Net Benefit / Total Cost \times 100 \% = \$5 , 000 / \$3 , 900 \times 100 \% = 128.2 \% .$$

Hence, in this corporate training scenario, the ROI Indicator is equal to roughly $1.28 for every dollar invested in training.

### ROI Calculation Example: Apprenticeship Training (Public Sector Contracting)

In another instance, the ROI Indicator may be applied to an apprenticeship training for public sector contracting using Eq. 2 as follows:

$$Net Benefits = Cost savings generated by employee during training period - Total Cost of Training$$

More specifically, Net Benefits=employee cost during training period−employer crew composition cost reduction (value of using apprentice to perform work vs full burden cost of journey worker)=value generated by employee during training=apprentice wage−% of journey wage saved by employer=value generated by employee during training=$45 per hour worked by apprentice (60% of Journey wage)−$30 per hour (40% of Journey wage)=$15 per hour Net Benefit.

Total Cost=employee training contribution cost paid hourly by employer for every hour worked typically includes the cost of training (including all cost e.g. instructor, material, certification, etc.) If cost of training is $10 for every hour worked, then:

$$ROI Indicator = Net Benefit / Total C ost \times 100 \% = \$15 / \$10 \times 100 \% = 150 \% .$$

Hence, in this public sector contracting example, the ROI Indicator is equal to $1.50 for every dollar invested in training.

### Intelligent Validation Measurable ROI Decision and Performance Scale

### Negative ROI Indicator (<0%):

Interpretation: The investment is losing money.
Decision Implication: Reassess and potentially discontinue.

### Marginal ROI Indicator (0-10%):

Interpretation: Minimal financial return.
Decision Implication: May warrant review; non-financial benefits might be justifiable.

### Moderate ROI Indicator (10-20%):

Interpretation: Moderate return, possibly justifying the investment.
Decision Implication: Consider continuation or scaling with caution; evaluate non-financial impacts.

### Healthy ROI Indicator (20-50%):

Interpretation: Solid financial return.
Decision Implication: Likely worth continuing, possibly scaling.

### High ROI Indicator (>50%):

Interpretation: Exceptionally profitable.
Decision Implication: Consider scaling and potentially applying learnings to other areas.

### User ROI Calculation Set-Up and Considerations

Define Objectives: Clearly outline what the training program aims to achieve in terms of skills development, performance improvement, and organizational impact.

Data Collection: Accumulate all relevant data pertaining to costs and expected/actual benefits from various departments (like HR, Finance, and Operations).

Choose Appropriate Metrics: Identify and use metrics that accurately reflect the benefits gained from the training, ensuring they're quantifiable and directly linked to the training.

Time-Frame Consideration: Determine the period over which the ROI will be calculated to capture both immediate and sustained impacts of the training.

Account for Intangibles: Be mindful of intangible benefits, such as improved employee morale or enhanced corporate culture, which may not be easily quantifiable but are valuable.

Analysis and Interpretation: Analyze and interpret the data, ensuring that any conclusions drawn are valid, reliable, and accurately reflect the impact of the training.

Documentation: Document all aspects of the ROI calculation process, including assumptions, models, and data sources, for transparency and future reference.

Continuous Evaluation: Regularly evaluate and adjust the training program based on ROI calculations and feedback to maximize impact and efficiency.

In sum, ROI Indicators for other performance metrics associated with one or more contracts may be determined by the system 100 and reflected as indicators including but not limited to drop-out rates, course selection, attendance rates, and any number of performance metrics which are calculated based on data stored and provided in table resources 400.

In different environments, industries, and applications, the term “contract” may use a terminology to define the client's utilization needs, yet the overall process, components, and end-user experience of the system 100 remain the same. For example, in the construction industry the term contract is generally the contractual agreement issued in a procurement process that establishes the requirements contractors need to meet as part of the conditions of being awarded the work. However, in another environment the contract could be a different type of governing document but would similarly contain the conditions that need to be met by the party being hired or overseen. This means that the contract in a corporate HR environment would be the employment policies, in a supplier environment would be the purchase agreement, in a government agency would be the regulatory requirements, and so on. Therefore, the contract is the instrument containing the rules or requirements to be considered compliant in that specific engagement.

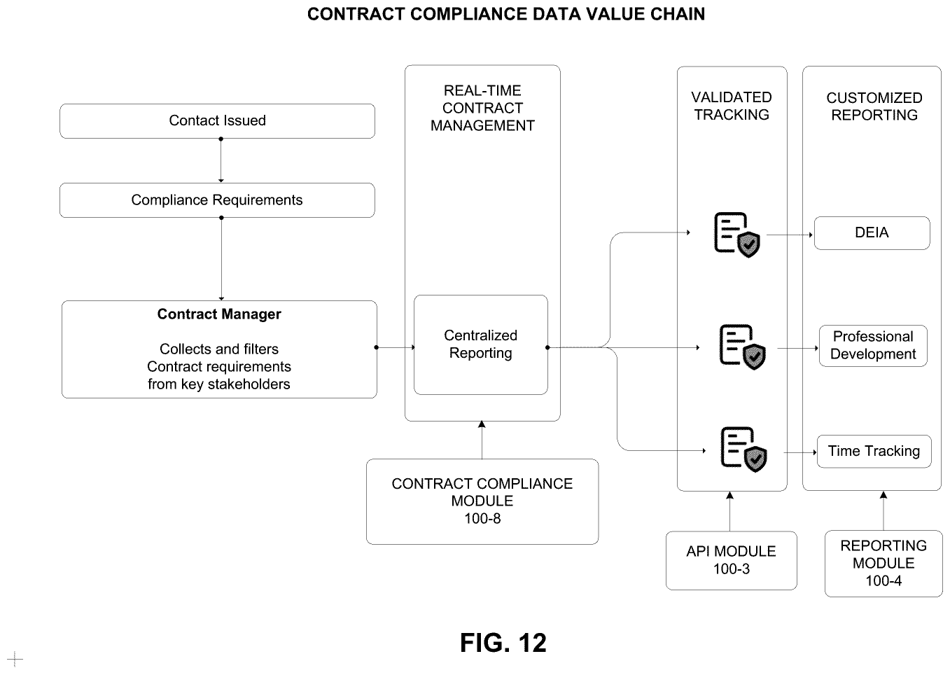

FIG. 12 illustrates a Contract Compliance Data Value Chain supported by the system 100, according to an embodiment. When a contract is issued, the contract compliance module 100-8 of the system 100 insures that all contract compliance requirements, management, and tracking thereof are available to 3^{rd} party stakeholders (e.g., contract managers, contractors, owners, etc.) who may access contract performance metrics via a real-time centralized reporting system. The centralized reporting system is configured to validate tracking via one or more API modules 100-3 in real-time of all compliance data, generating unlimited types of customized reports via the Reporting module 100-4 by category (e.g., Diversity, equity, inclusion, and accessibility (DEIA), professional development, time tracking, etc.) for the 3^{rd} party stakeholders to determine success and failure outcomes for issued contracts.

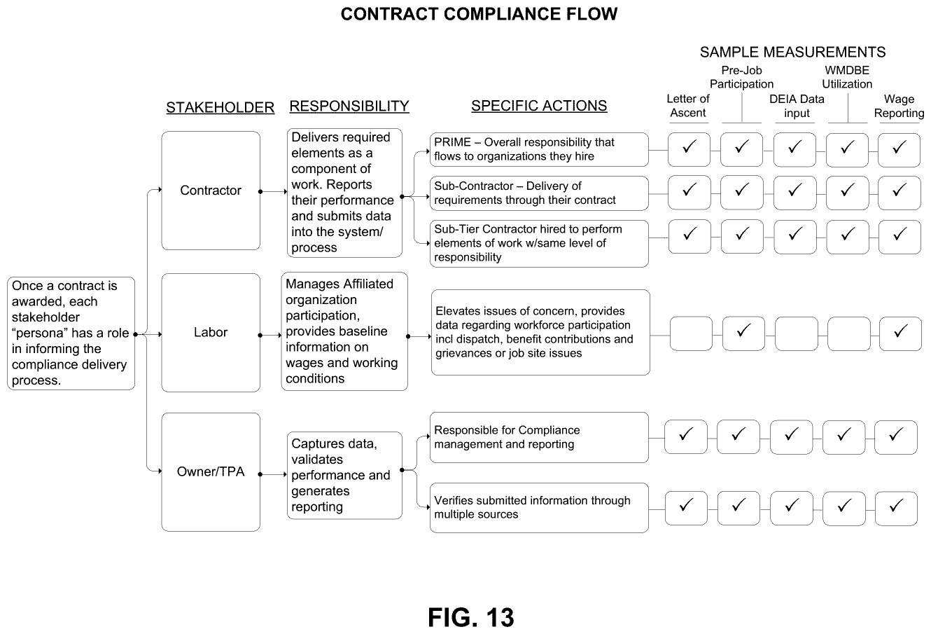

FIG. 13 illustrates a Contract Compliance flowchart supported by the system 100, according to an embodiment. Once a contract is awarded, each stakeholder (e.g., contractor, labor, owner/TPA) has a role, responsibility, and designated action in making data submissions to the system 100 at key steps in the compliance delivery process. For example, a contractor may deliver required elements as a component of work and reports their performance by submitting data into the system 100. In addition, specific actions associated with contractor are assigned to subgroup contractors (Prime, Sub-contractor, sub-tier contractor) who submit their data into the system 100 according to their specific duties and requirements. A labor representative who manages affiliated organization participation can submit baseline information on wages and working conditions to the system 100. For example, the labor representative's action may include elevating issues of concern and submitting data in the system 100 regarding workforce participation including dispatch, benefit contributions and grievances or job site issues. An owner/TPA is generally responsible for compliance management and reporting, capturing data and validating its performance. The owner/TPA may also take specific actions to verify submitted information through multiple data sources. Sample measurements and data collected by each stakeholder may include letters of ascent, pre-job participation, DEIA data input, MWDBE utilization, and wage reporting. All data submissions made to the system 100 by any of the stakeholders are handled via the user access interface module 100-2c.

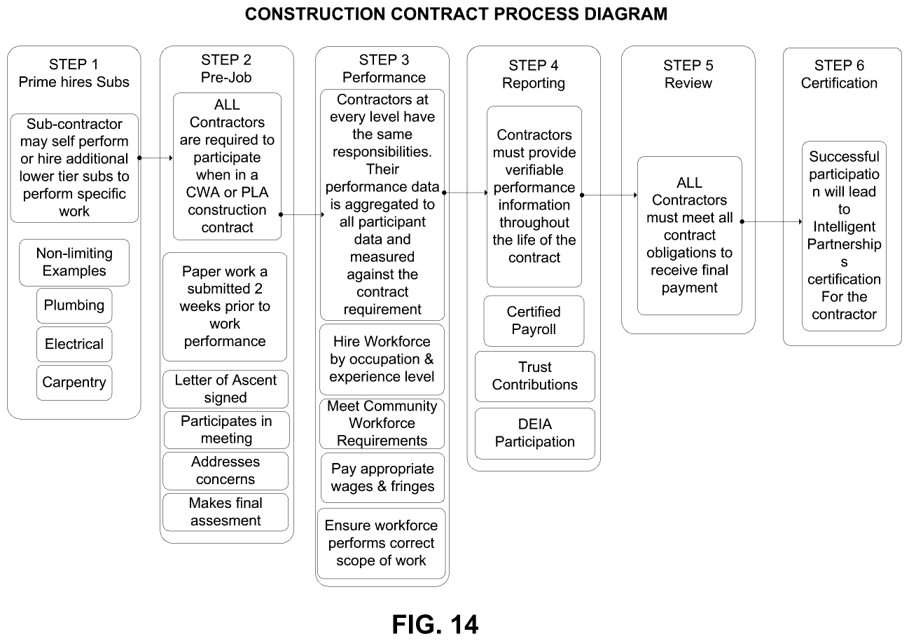

FIG. 14 illustrates an application of a contract process in a construction contracting environment as supported by the system 100, according to an embodiment. In the construction environment, the contract process has six primary steps: 1) Prime Hires Subs; 2) Pre-Job; 3) Performance; 4) Reporting; 5) Review; and 6) Certification. In Step 1 (Prime Hires Subs), Sub-contractor may self-perform or hire additional lower tier sub-contractors to perform specific jobs, including plumbing, electrical, and carpentry, for example. In Step 2 (Pre-Job), all contractors are required to participate when in a CWA or PLA construction contract where paper work must be submitted 2 weeks prior to work performance, a letter of ascent must be signed, all contractors participate in scheduled meetings, issues and concerns are addressed, and a final assignment is made. In Step 3 (Performance), all contractors at every level have the same responsibilities, including but not limited to hiring workforce by occupation and experience level, meeting community workforce requirements, paying appropriate wages and benefits, and ensuring workforce performs correct scope of work. Contractors' performance data is aggregated to all participant data and measured against the contract requirement by the system 100. In Step 4 (Reporting), contractors must provide verifiable performance information throughout the life of the contract in relation to finance and socio-demographic matters which may include but are not limited to certified payroll, trust contributions, and DEIA participation. In Step 5 (Review), all contractors are reviewed by the system 100 which determines if all contract obligations achieved before final payment is released to the contractor. In Step 6 (Certification), contractors receive their certification upon meeting all requirements after the system 100 determines their participation is successful.

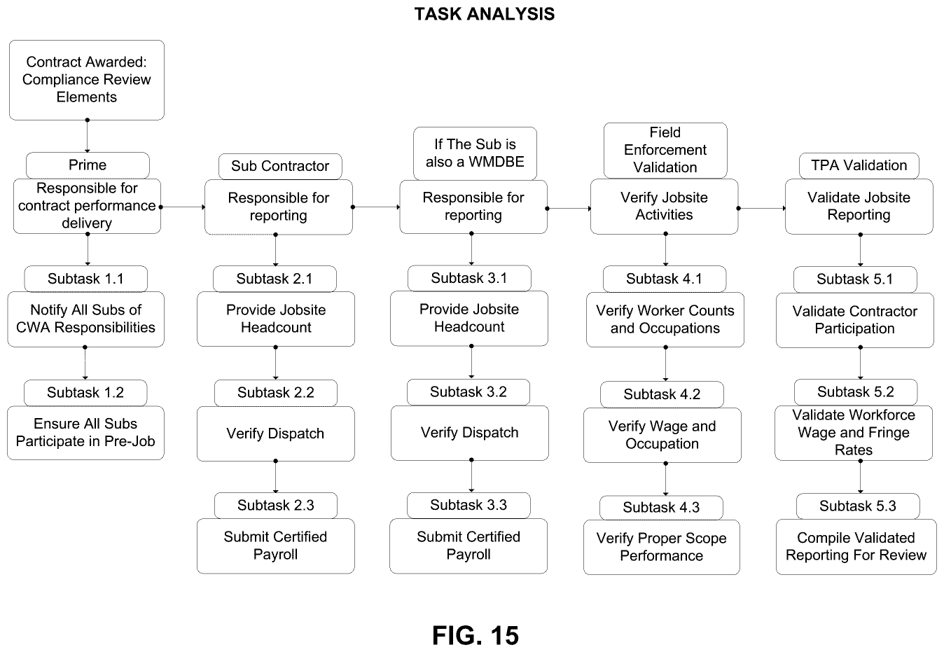

FIG. 15 illustrates a Task Analysis flowchart supported by the system 100, according to an embodiment. Once a contract is awarded at intake, the processes by which elements are reviewed for compliance may be broken into distinct tasks performed by a given stakeholder (prime contractor, sub-contractor, WMBDE sub-contractor, TPA, etc.). For example, at intake, one responsibility of the prime contractor is to insure contract performance delivery, including actions performed in subtasks 1.1 (notify all subcontractors of CWA responsibilities) and 1.2 (ensure all subcontractors participate in pre-job activities). Next, upon completion of the prime contractor's duties, the subcontractors are responsible for reporting all job activities and performing their designated tasks (Subtask 2.1, 2.2, and 2.3). In some cases, the subcontractor has a role in Minority, Women and Disadvantaged Business Enterprise (MWDBE) whereby additional designated tasks are performed (e.g., Subtasks 3.1, 3.2, and 3.3) for this type of subcontractor. Next, once reporting by the prime contractors and subcontractors are completed, a field enforcement validation step is performed to verify jobsite activities, including verifying worker counts and occupations, wages and occupations, and proper scope performance as shown in Subtasks 4.1 to 4.3, respectively. Once jobsite activities are verified, a TPA validation step for validating jobsite reporting may include the tasks of validating contractor participation (Subtask 5.1), validating workforce wage and fringe rates (Subtask 5.2), and compiling validated reporting for review (Subtask 5.3).

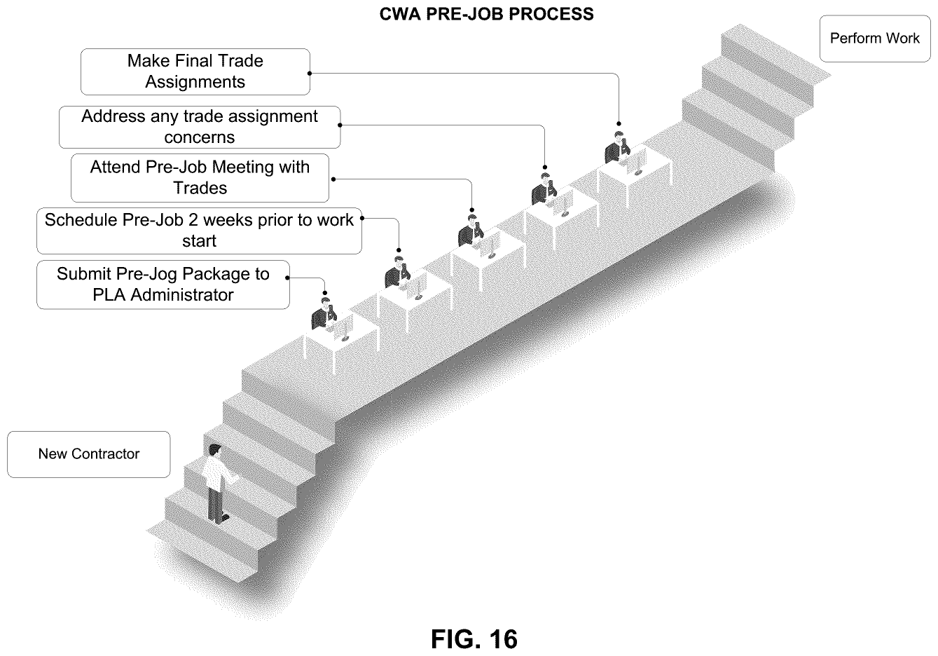

FIG. 16 illustrates a CWA Pre-Job process supported by the system 100, according to an embodiment. The CWA Pre-Job process is a simple administrative review of trade assignments for each project job scope. It is usually managed in a single meeting and can remove any concerns about Contractor interactions with Labor representatives. The process intake for a New Contractor may include the steps of 1) Submitting Pre-Job Package to PLA Administrator, Scheduling Pre-Job 2 weeks prior to work start, attending Pre-Job Meeting with Trades, addressing any trade assignment concerns, making Final Trade Assignments, and performing work by the contractor.

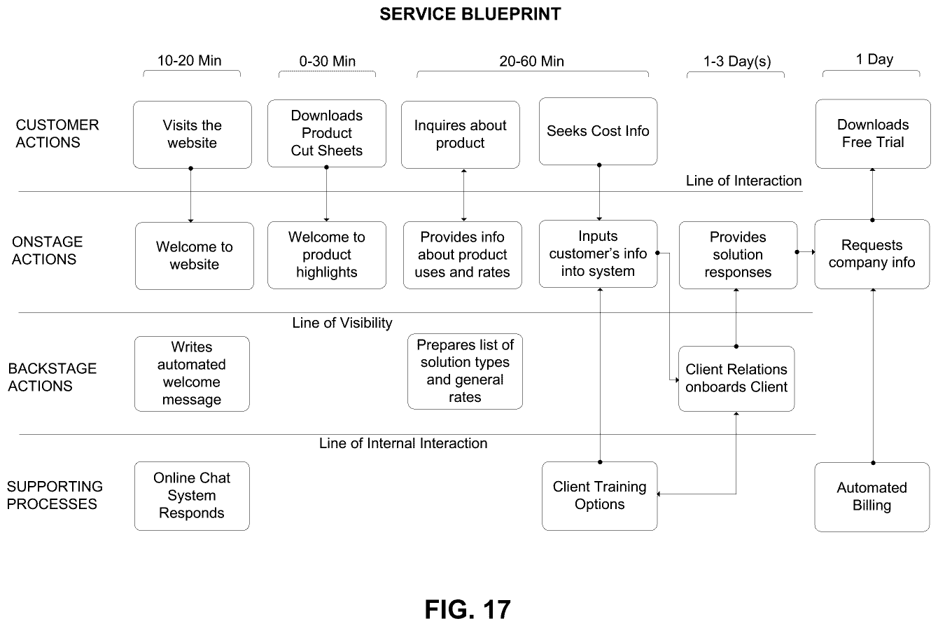

FIG. 17 illustrates a Service Blueprint flowchart supported by the system 100, according to an embodiment. The Service Blueprint provides a general overview of a customer's (i.e., user) experience and interactions while accessing and utilizing features of the web interface module 100-2 in the system 100. The Service Blueprint is partitioned into four action groups initiated via 1) customer actions; 2) onstage/displayed actions; 3) backstage/system actions, and 4) supporting system processes. When a customer accesses the system 100 via the web interface module 100-2, the system 100 acknowledges the customer with initial welcome notification and then provides the customer automated messages and online chat features for making customer inquiries and receiving feedback from the system. After their initial visit, the system 100 provides product cut sheets from which the user may download. The system 100 may provide additional information to the user via product or service cut sheets highlights. The customer may also make inquiries via the web interface module 100-2 about products or services whereby the system 100 provides and generates a list of solutions of the customer information about usage and rates of product/service offerings. In addition, the customer may seek and request other cost information on the product/service offerings on the system 100 whereby the customer's information is received and entered into the web interface module 100-2 and additional training options information from the system 100 is provided. Upon receiving the customer's information, the system 100 may respond by initiating a user onboarding process, providing the solution responses to the user. In turn, the system 100 may request company information, perform automated billing functions, and provide free download trials to the user via the web interface module 100-2.

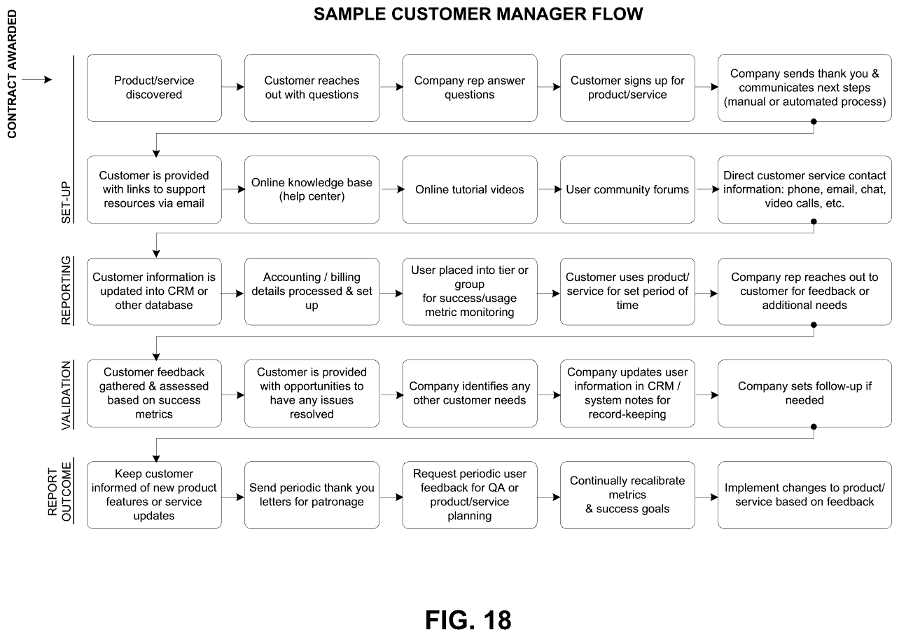

FIG. 18 illustrates a Sample Customer Management flowchart supported by the system 100, according to an embodiment. Upon receiving a contract award by a company, the system 100 is configured to support and manage various phases of customer interactions therein, including: 1) a set-up phase; 2) a reporting phase; 3) a validation phase; and 4) a reporting outcome phase. In the set-up phase, the system 100 may offer products/services that are of interest to customers who may discover and learn more about these offering on the web interface module 100-2 of the system 100. During the set-up phase, customers may reach out with questions, have questions answered by the company representatives, enroll and sign-up for products and services, receive notifications on next steps from the company, receive links to support resources via email, access online knowledge base, access tutorial videos, access and participate in user community forums, and have direct customer service contact information provided to them. During the reporting phase, the system 100 may update customer information into CRM or other databases, process and set-up all accounting and billing details, place users into tiers or groups for success and usage metric monitoring, allow customers to use products/services for a set period of time, and coordinate company representatives to reach out to customers for feedback and other needs. In the validation phase, the system 100 may acquire customer feedback and assess it based on predetermined success metrics, provide customers with opportunities to resolve issues, allow the company to identify other needs of customers, perform record-keeping tasks by allowing the company to update user information in the CRM or system, and arrange follow-up feedback interaction between the company and customers. In the reporting outcome phase, the system 100 may keep the customer informed of new product features or service updates, send periodic correspondences (regular mail, email, or text) to customers, request periodic customer feedback for QA or product/service planning, continually recalibrate metrics and success goals, and implement changes to products and services based on customer feedback.

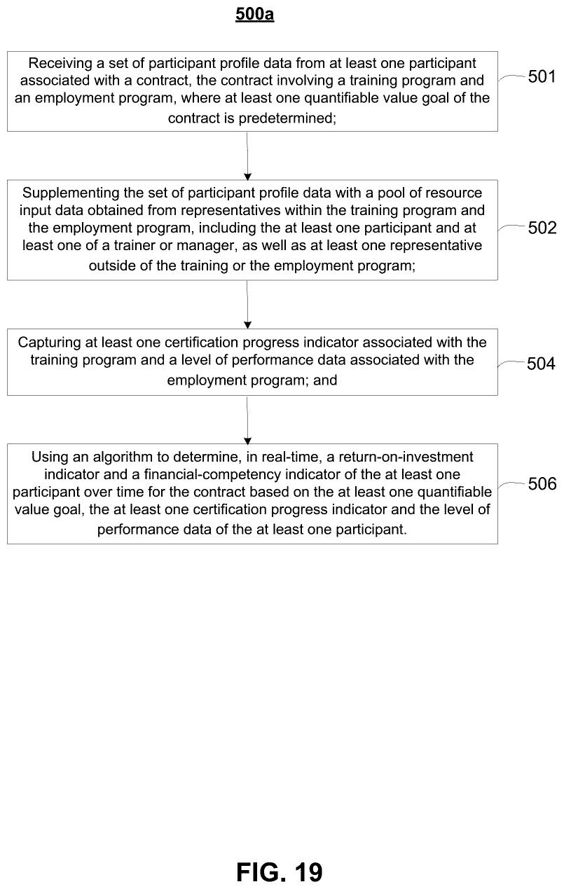

FIG. 19 illustrates a method 500a of apprenticeship contract compliance and performance validation executed by one or more processors in a computer network environment, according to an embodiment. The method 500a of apprenticeship contract compliance and performance validation may include performing steps 501) receiving a set of participant profile data from at least one participant associated with a contract, the contract involving a training program and an employment program, where at least one quantifiable value goal of the contract is predetermined; 502) supplementing the set of participant profile data with a pool of resource input data obtained from representatives within the training program and the employment program, including the at least one participant and at least one of a trainer or manager, as well as at least one representative outside of the training or the employment program; 504) capturing at least one certification progress indicator associated with the training program and a level of performance data associated with the employment program; and 506) using an algorithm to determine, in real-time, a return-on-investment indicator and a financial-competency indicator of the at least one participant over time for the contract based on the at least one quantifiable value goal, the at least one certification progress indicator and the level of performance data of the at least one participant. In one aspect, the participant (e.g., apprentice) may include but is not limited to any individual or user who is enrolled in an apprenticeship or training program of the system 100. In another aspect, the set of participant profile data may include but is not limited to information about a participant, such as their name, contact details, skills, and qualifications, or any content defined in the users or userProfile data in the database schema of table resources 400. The contract according to this method may include but is not limited to any formal agreement that outlines the terms and conditions of the work delivery requirements including workforce conditions of employment. The training program may include but is not limited to any structured educational program designed to develop specific skills or competencies, such as apprenticeship programs related to Information Technology, Plumbing, Electrician, and so on. The employment program may include but is not limited to any program that provides job placement or employment support for participants, helping apprentices find job opportunities after completing training. The quantifiable value goal of the contract may include but is not limited to a measurable objective within the contract that both parties aim to achieve such as, for example, a goal of the contract is for the employer to achieve 20% utilization of women as apprentices. The pool of resource input data may include but is not limited to any collection of resources like materials, instructors, information on progress/milestones for determining financial and ROI metrics, and equipment used in the program. The trainer or manager may include but is not limited to any person responsible for instructing and guiding participants in course training journey. The outside representative may include but is not limited to any external stakeholder who may be involved in the participant's journey or program evaluation. The certification progress indicator may include but is not limited to a measure of a participant's progress toward achieving certifications or qualifications as determined by the data analysis module 100-6 of the system 100. The level of performance data may include but is not limited to data indicating how well an employer is performing in their contract compliance obligation. The algorithm may include but is not limited to executable software or hardware instructions for solving a class of specific problems, performing calculations, and or data processing. The return-on-investment indicator may include but is not limited to any metric used to assess the effectiveness and value of the investment in the apprenticeship or training program. The financial-competency indicator may include but is not limited to a measurement of the employer's financial impact and management skills.

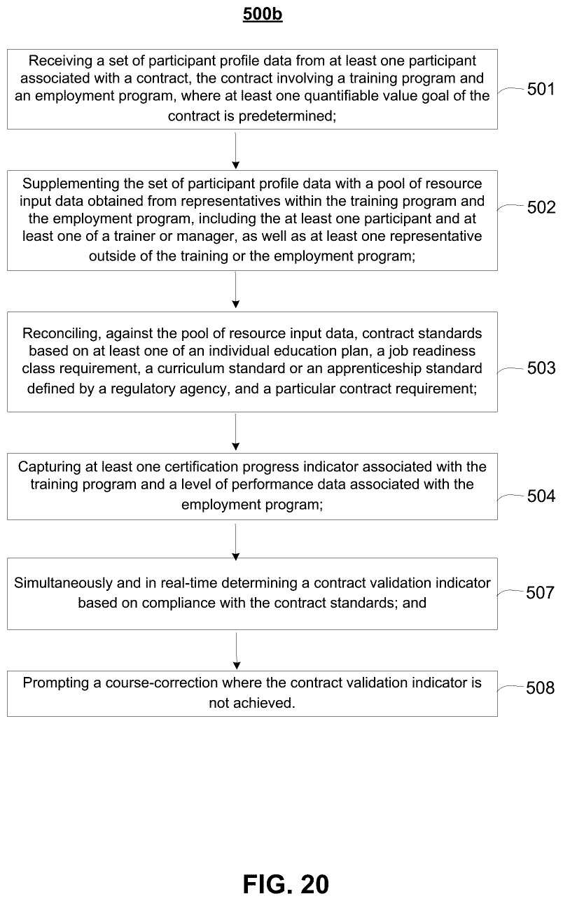

FIG. 20 illustrates another method 500b of apprenticeship contract compliance and performance validation executed by one or more processors in a computer network environment, according to an embodiment. The method 500b of apprenticeship contract compliance and performance validation may include performing steps 501) receiving a set of participant profile data from at least one participant associated with a contract, the contract involving a training program and an employment program, where at least one quantifiable value goal of the contract is predetermined; 502) supplementing the set of participant profile data with a pool of resource input data obtained from representatives within the training program and the employment program, including the at least one participant and at least one of a trainer or manager, as well as at least one representative outside of the training or the employment program; 503) reconciling, against the pool of resource input data, contract standards based on at least one of an individual education plan, a job readiness class requirement, a curriculum standard or an apprenticeship standard defined by a regulatory agency, and a particular contract requirement; 504) capturing at least one certification progress indicator associated with the training program and a level of performance data associated with the employment program; 507) simultaneously and in real-time determining a contract validation indicator based on compliance with the contract standards; and 508) prompting a course-correction where the contract validation indicator is not achieved. Terms and elements discussed in the method 500a are omitted in this section for brevity, while specific terms and elements pertaining to the current exemplary method 500b are covered in this section only. The contract standards in this exemplary method may include but are not limited to any defined guidelines and requirements that must be followed within a procurement contract which specifies and defines guidelines and requirements that are issued by a corporate or government purchaser. The individual education plan may include but is not limited to any personalized learning plan tailored to each participant's needs and goals. The job readiness class requirement may include but is not limited to any specific class or training module designed to prepare participants for employment. The curriculum standard may include but is not limited to any set of predefined educational objectives and content for a specific course or program. The apprenticeship standard may include but is not limited to any framework defining the criteria and expectations for apprenticeship programs. The regulatory agency may include but is not limited to any government or industry authority that oversees and regulates contract, employment or business wages and licensing. The contract requirement may include but is not limited to any condition or obligation that must be fulfilled as part of the apprenticeship contract. The contract validation indicator may include but is not limited to any process of ensuring that the contract performance meets all procurement, legal and regulatory requirements. The course-correction may include but is not limited to any adjustments or changes made to the program or participant's plan by the system 100 when progress veers off track.

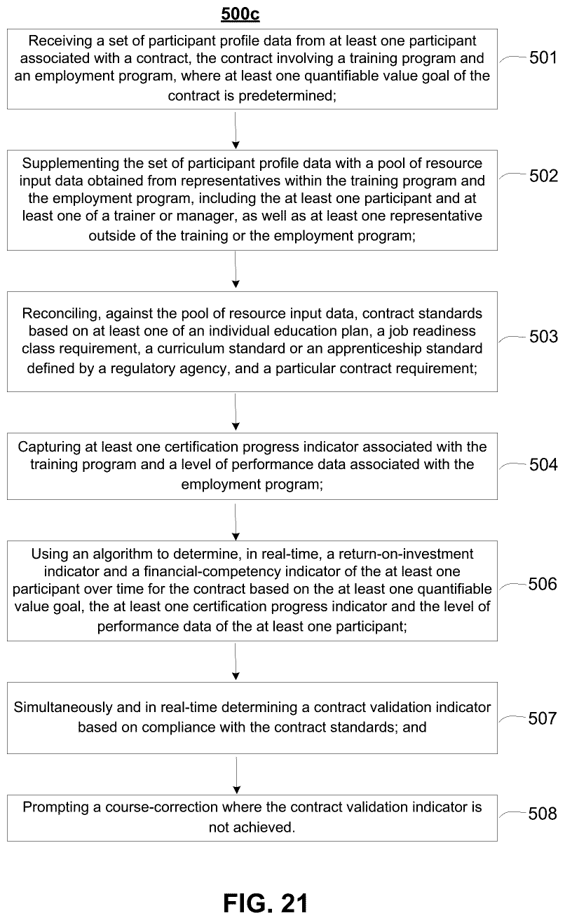

FIG. 21 illustrates another method 500c of apprenticeship contract compliance and performance validation executed by one or more processors in a computer network environment, according to an embodiment. The method 500c of apprenticeship contract compliance and performance validation may include performing steps 501) receiving a set of participant profile data from at least one participant associated with a contract, the contract involving a training program and an employment program, where at least one quantifiable value goal of the contract is predetermined; 502) supplementing the set of participant profile data with a pool of resource input data obtained from representatives within the training program and the employment program, including the at least one participant and at least one of a trainer or manager, as well as at least one representative outside of the training or the employment program; 503) reconciling, against the pool of resource input data, contract standards based on at least one of an individual education plan, a job readiness class requirement, a curriculum standard or an apprenticeship standard defined by a regulatory agency, and a certification progress indicator associated with the training program and a level of performance data associated with the employment program; 506) using an algorithm to determine, in real-time, a return-on-investment indicator and a financial-competency indicator of the at least one participant over time for the contract based on the at least one quantifiable value goal, the at least one certification progress indicator and the level of performance data of the at least one participant; 507) simultaneously and in real-time determining a contract validation indicator based on compliance with the contract standards; and 508) prompting a course-correction where the contract validation indicator is not achieved.

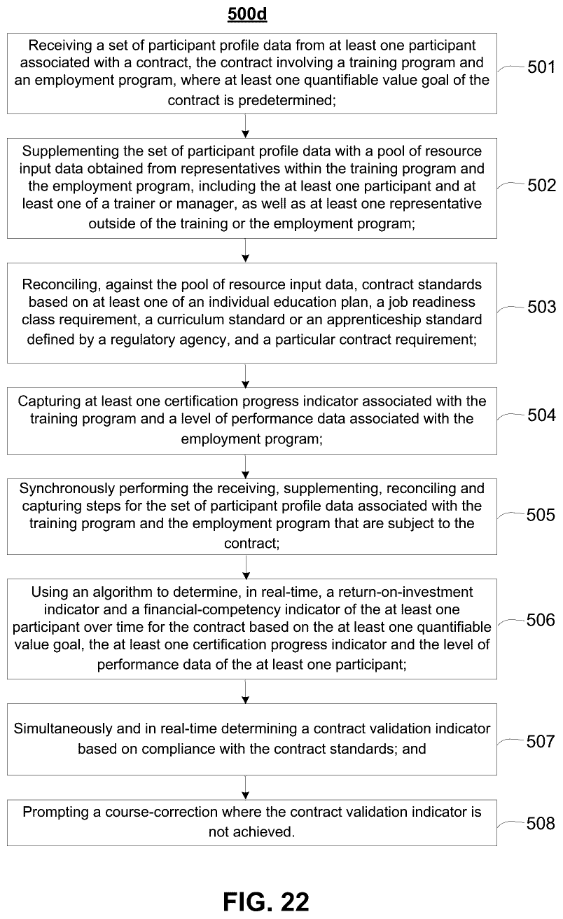

FIG. 22 illustrates another method 500d of apprenticeship contract compliance and performance validation executed by one or more processors in a computer network environment, according to an embodiment. The method 500d of apprenticeship contract compliance and performance validation may include performing steps 501) receiving a set of participant profile data from at least one participant associated with a contract, the contract involving a training program and an employment program, where at least one quantifiable value goal of the contract is predetermined; 502) supplementing the set of participant profile data with a pool of resource input data obtained from representatives within the training program and the employment program, including the at least one participant and at least one of a trainer or manager, as well as at least one representative outside of the training or the employment program; 503) reconciling, against the pool of resource input data, contract standards based on at least one of an individual education plan, a job readiness class requirement, a curriculum standard or an apprenticeship standard defined by a regulatory agency, and a certification progress indicator associated with the training program and a level of performance data associated with the employment program; 505) Synchronously performing the receiving, supplementing, reconciling and capturing steps for the set of participant profile data associated with the training program and the employment program that are subject to the contract; 506) using an algorithm to determine, in real-time, a return-on-investment indicator and a financial-competency indicator of the at least one participant over time for the contract based on the at least one quantifiable value goal, the at least one certification progress indicator and the level of performance data of the at least one participant; 507) simultaneously and in real-time determining a contract validation indicator based on compliance with the contract standards; and 508) prompting a course-correction where the contract validation indicator is not achieved.

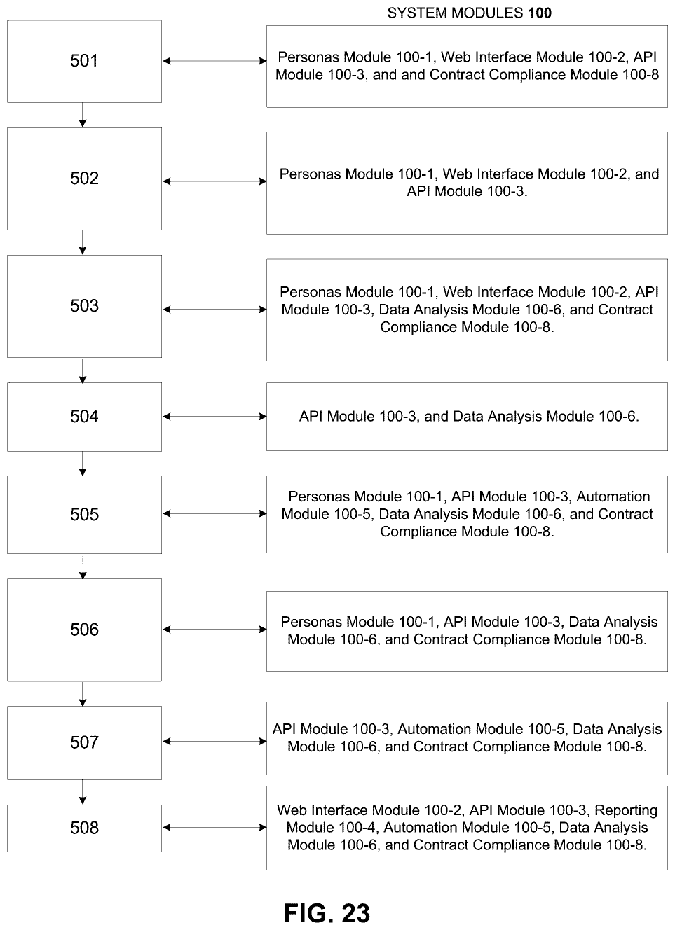

FIG. 23 illustrates linked system modules of the apprenticeship contract compliance and performance validation methods (500a-500d) operating under control of the system 100, in accordance to an embodiment. In one instance, the step 501 (i.e., receiving a set of participant profile data . . . ) is generally processed in part by at least the Personas Module 100-1 for handling and managing participants, the Web Interface Module 100-2 for providing a portal and user interface through which data is conveyed to the end user, the API Module 100-3 for executing internal data operations and functions calls to perform such methods in the system 100, and the Contract Compliance Module 100-8 for communicating and handling contract information in the method 501. In another instance, the step 502 (i.e., supplementing the set of participant profile data . . . ) is processed in part by at least the Personas Module 100-1, the Web Interface Module 100-2, and the API Module 100-3. In yet another instance, the step 503 (i.e., reconciling, against the pool of resource input data, contract standards . . . ) is managed in part by at least the Personas Module 100-1, the Web Interface Module 100-2, the API Module 100-3, the Data Analysis Module 100-6, and the Contract Compliance Module 100-8. In still yet another instance, the step 504 (i.e., capturing at least one certification progress indicator . . . ) is generally processed in part by at least the API Module 100-3, and the Data Analysis Module 100-6. In yet another instance, the step 505 (i.e., synchronously performing the receiving, supplementing, reconciling and capturing steps . . . ) is processed in part by at least the Personas Module 100-1, the API Module 100-3, the Automation Module 100-5, the Data Analysis Module 100-6, and the Contract Compliance Module 100-8. In yet another instance, the step 506 (i.e., using an algorithm to determine, in real-time, a return-on-investment indicator . . . ) is processed in part by at least the Personas Module 100-1, the API Module 100-3, the Data Analysis Module 100-6, and the Contract Compliance Module 100-8. In yet another instance, the step 507 (i.e., simultaneously and in real-time determining a contract validation indicator . . . ) is handled in part by at least the API Module 100-3, the Automation Module 100-5, the Data Analysis Module 100-6, and the Contract Compliance Module 100-8. In still yet another instance, the step 508 (i.e., prompting a course-correction . . . ) is managed in part by at least the Web Interface Module 100-2, the API Module 100-3, the Reporting Module 100-4, the Automation Module 100-5, the Data Analysis Module 100-6, and the Contract Compliance Module 100-8.

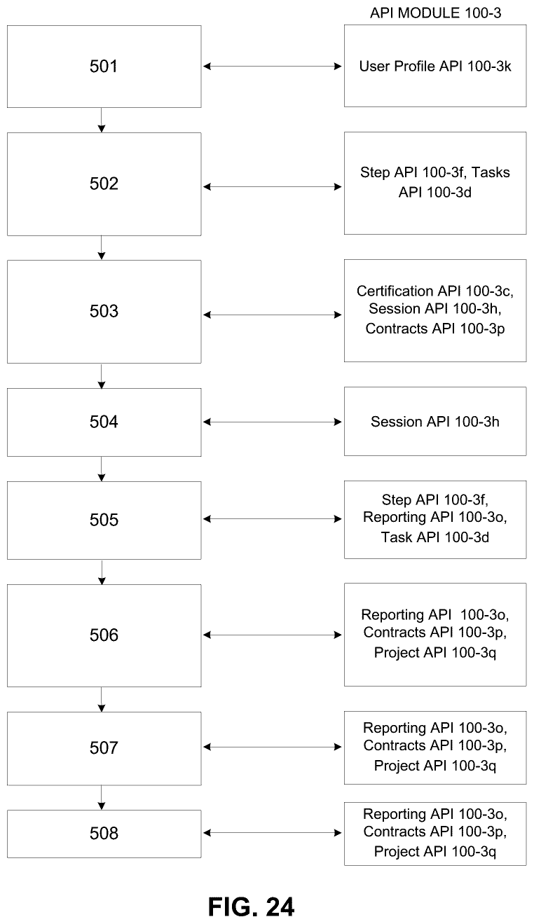

FIG. 24 illustrates linked API modules of the apprenticeship contract compliance and performance validation methods (500a-500d) operating under control of the system 100, in accordance to an embodiment. In one instance, API modules linked to step 501 (i.e., receiving a set of participant profile data . . . ) include at least the User Profile API 100-3k for facilitating data transactions related to the participant profile data. API modules linked to step 502 (i.e., supplementing the set of participant profile data . . . ) include at least the Step API 100-3f and Task API 100-3f for processing the pool of resource data from the representative within the training program and employment program. API modules linked to step 503 (i.e., reconciling, against the pool of resource input data, contract standards . . . ) include at least the Certification API 100-3c, Session API 100-3h, and Contracts API 100-3p for facilitating data transactions during the reconciliation of the contract standards. API modules linked to step 504 (i.e., capturing at least one certification progress indicator . . . ) include at least the Session API 100-3h for facilitating data transactions of the certification progress indicator and level of performance data. API modules linked to step 505 (i.e., synchronously performing the receiving, supplementing, reconciling and capturing steps . . . ) include at least the Step API 100-3f, Reporting API 100-3o, and Task API 100-3d for facilitating data transactions during the synchronization process. API modules linked to step 506 (i.e., using an algorithm to determine, in real-time, a return-on-investment indicator . . . ) include at least the Reporting API 100-3o, Contracts API 100-3p, and Project API 100-3q for facilitating data transactions during the ROI determination process. API modules linked to step 507 (i.e., simultaneously and in real-time determining a contract validation indicator . . . ) include at least the Reporting API 100-3o, Contracts API 100-3p, and Project API 100-3q for determining the contract validation indicator. API modules linked to step 508 (i.e., prompting a course-correction . . . ) include at least the Reporting API 100-3o, Contracts API 100-3p, and Project API 100-3q for facilitating data transactions used to initiate the step of prompting the course-correction.

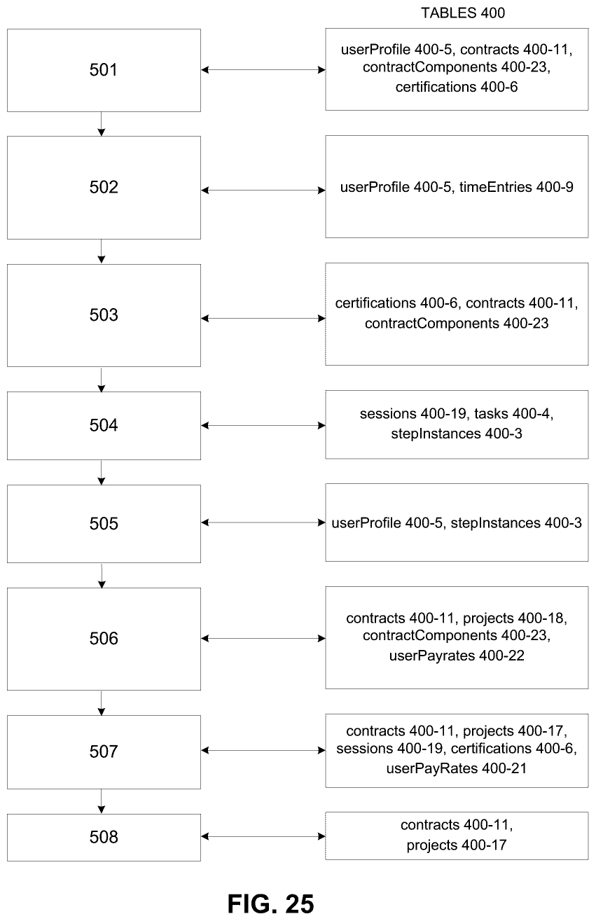

FIG. 25 illustrates linked tables of the apprenticeship contract compliance and performance validation methods (500a-500d) operating under control of the system 100, in accordance to an embodiment. In one instance, tables linked to step 501 (i.e., receiving a set of participant profile data . . . ) may include at least the userProfile 400-5, contracts 400-11, contractComponents 400-23, and certifications 400-6 tables for storing and/or retrieving participant profile data, contract data, goals, and training/employment programs data. Tables linked to step 502 (i.e., supplementing the set of participant profile data . . . ) may include at least the userProfile 400-5 and timeEntries 400-9 for storing and/or retrieving data participant data, pool or resource data, and training/employment programs data. Tables linked to step 503 (i.e., reconciling, against the pool of resource input data, contract standards . . . ) may include at least the certifications 400-6, contracts 400-11, and contractComponents 400-23 tables for storing and/or retrieving contract requirements, contract standards, educational plans, and curriculum standard. Tables linked to step 504 (i.e., capturing at least one certification progress indicator . . . ) may include at least the sessions 400-19, tasks 400-4, and stepInstances 400-3 tables for storing and/or retrieving the certification progress indicator, level of performance data, and training/employment programs data. Tables linked to step 505 (i.e., synchronously performing the receiving, supplementing, reconciling and capturing steps . . . ) may include at least the userProfile 400-5, and stepInstances 400-3 tables for storing and/or retrieving the participant profile data and training/employment programs data. Tables linked to step 506 (i.e., using an algorithm to determine, in real-time, a return-on-investment indicator . . . ) may include at least the contracts 400-11, projects 400-18, contractComponents 400-23, and userPayrates 400-22 tables for storing and/or retrieving ROI data, finance data, contract data, and user pay data. Tables linked to step 507 (i.e., simultaneously and in real-time determining a contract validation indicator . . . ) may include at least the contracts 400-11, projects 400-17, sessions 400-19, certifications 400-6, and userPayRates 400-21 tables for storing and/or retrieving contract standards and compliance data for determining the contract validation indicator. Tables linked to step 508 (i.e., prompting a course-correction . . . ) may include at least the contracts 400-11 and projects 400-17 tables for storing and/or retrieving contract data for determining the course-correction response.

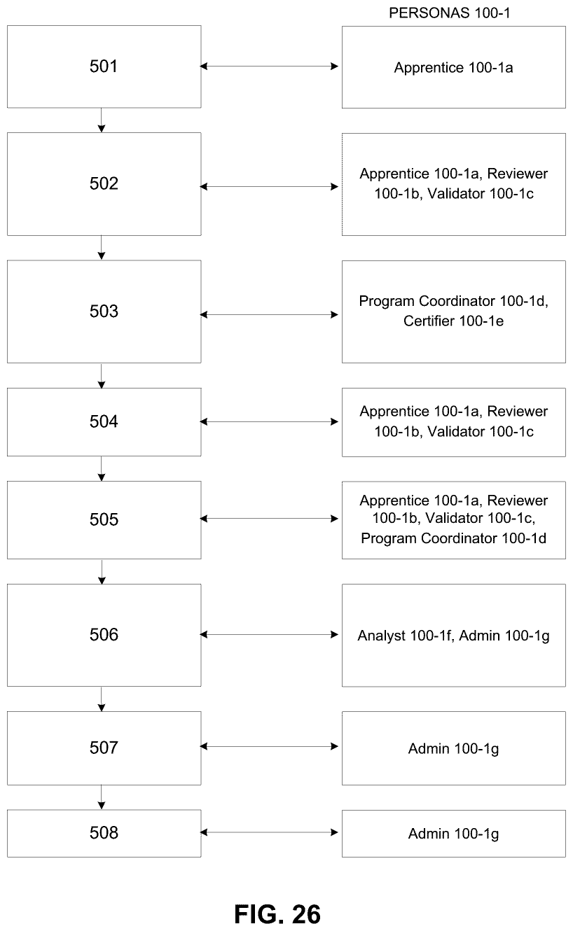

FIG. 26 illustrates linked personas of the apprenticeship contract compliance and performance validation methods (500a-500d) operating under control of the system 100, in accordance to an embodiment. In one instance, personas linked to step 501 (i.e., receiving a set of participant profile data . . . ) may include at least the Apprentice 100-1a acting as the participant. Personas linked to step 502 (i.e., supplementing the set of participant profile data . . . ) may include at least the Apprentice 100-1a, Reviewer 100-1b, and Validator 100-1c for supporting the supplementing activities at this step. Personas linked to step 503 (i.e., reconciling, against the pool of resource input data, contract standards . . . ) may include at least the Program Coordinator 100-1d and Certifier 100-1e for supporting the reconciliation activities at this step. Personas linked to step 504 (i.e., capturing at least one certification progress indicator . . . ) may include at least the Apprentice 100-1a, Reviewer 100-1b, Validator 100-1c for supporting the capture activities at this step. Personas linked to step 505 (i.e., synchronously performing the receiving, supplementing, reconciling and capturing steps . . . ) may include at least the Apprentice 100-1a, Reviewer 100-1b, Validator 100-1c, and Program Coordinator 100-1d for supporting the synchronization activities at this step. Personas linked to step 506 (i.e., using an algorithm to determine, in real-time, a return-on-investment indicator . . . ) may include at least the Analyst 100-1f and Admin 100-1g for supporting the determination of ROI activities at this step. Personas linked to steps 507 (i.e., simultaneously and in real-time determining a contract validation indicator . . . ) and 508 (i.e., prompting a course-correction . . . ) may include at least the Admin 100-1g for supporting the contract and course-correction activities at this step.

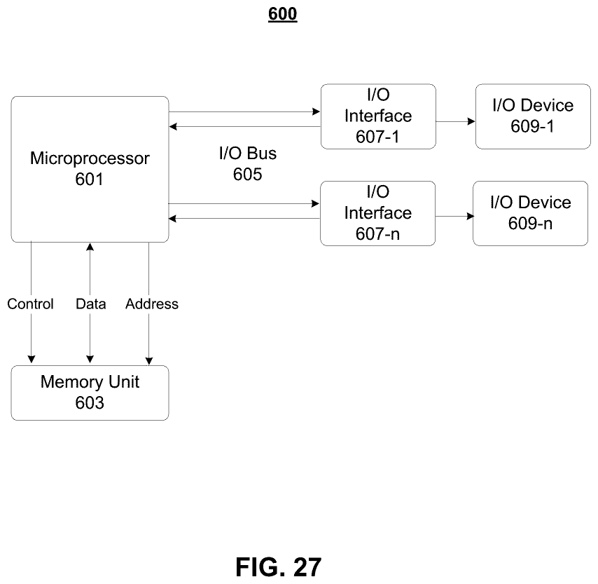

FIG. 27 illustrates a block diagram of a computer structure 600 in the system 100 for executing processes, instructions, and methods therein, according to an embodiment. Components of the computer structure 600 may include a microprocessor 601, a memory unit 603, Input/Output (I/O) Bus 605, I/O interfaces (607-1 to -n), and I/O devices (609-1 to -n).

The microprocessor 601 handles all processor control signals via a control unit, directing all input and output flow and fetching code for instructions. In addition, the microprocessor 601 handles all the calculations it requires via an arithmetic logic unit (ALU) which performs Arithmetic Operations (addition, subtraction, and comparison), Logical Operations, and Bit Shifting Operations.

The memory unit 603 may contain separate registers for storing and tracking instructions processed by the microprocessor 601. For example, memory locations of instructions that need to be fetched from memory or stored into memory are stored via a Memory Address Register (MAR). Instructions fetched from memory or any data that is to be transferred to, and stored in, is stored in a Memory Data Register (MDR). Most recently fetched instructions while waiting to be coded and executed are stored in a Current Instruction Register (CIR), and instruction that is not immediately executed is placed in an instruction buffer register IBR.

The Input/Output (I/O) Bus 605 is the data pathway that connects peripheral devices to the microprocessor 601 and is generally responsible for transferring data between the I/O devices and the microprocessor 601 or memory unit 603. In particular, the (I/O) Bus 605 is a separate bus that is used exclusively for communication between an I/O Processor of the (I/O) Bus 605 and the microprocessor 601 or memory unit 603.

The I/O interfaces (607-1 to -n) are hardware interface components and methods by which data are sent from microprocessor 601 to external devices (609-1 to -n), controlling and synchronizing all the input and output transfers between the external devices and microprocessor 601.

The I/O devices (609-1 to -n) input/output (I/O) may be any hardware device that is capable of receiving input and output data. Data communication in I/O devices (609-1 to -n) data is considered bi-directional (two-way communication). Examples of I/O devices are floppy/hard disk drives, USB flash drives, CD/DVD-ROM drives, network adapters, Bluetooth adapters/dongles, and webcams.

Data transmission and flow between internal components are managed via control, status, and data lines via command signals. For example, the control line may receive a control command signal to activate the peripheral. The status line may receive a status command signal to check a set of conditions in the interface and the peripheral device before employing other commands. The data lines may include a Data Input Line and Data Output Line whereby a data input command signal on the Data Input Line retrieves a portion of data from the peripheral device and sends it to buffer register while a data output command signal on the Data Output Line creates the interface counter to the command by sending data from the bus to one of its registers.

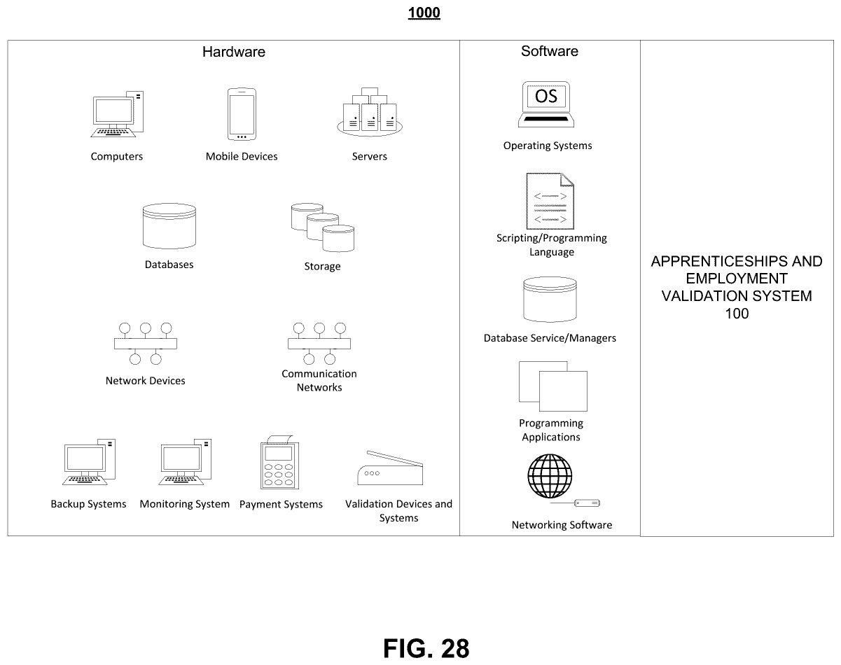

FIG. 28 illustrates a system level block diagram 1000 of backend hardware and software components of the system 100, according to an embodiment. In an implementation, the system 100 is supported by hardware and software components to facilitate routine operations and workflow while administering all services rendered to clients, participants, and users. In one aspect, hardware components in the system 100 include but are not limited to computers, mobile devices, local and remote servers, databases, mass storage devices, network devices, communication networks, backup systems, monitoring systems, payment systems, and validation devices and systems. In another aspect, software components in the system 100 include but are not limited to operating systems (OS), scripting or programming languages, programming applications, database management systems, and networking software. Portions of the system 100 and modules thereof may include a framework that is built from object-oriented programming languages included but not limited to Perl, PHP, C++, C#, Python, and Java. In addition, embodiments of the techniques described hereinabove may be performed and executed by a computer device or electronic device including but not limited to a non-transitory machine-readable medium having instructions stored thereon. These instructions are configured to cause the computer or electronic device to execute a portion or all of the operations of the system 100 described above. For example, the non-transitory machine-readable medium may include but is not limited to floppy disks, ROMS, RAMS, magnetic hard disk drives, compact disc read-only memories (CD-ROMs), erasable programmable read-only memories (EPROMs), magnetic cards, optical cards, or flash memory. Furthermore, the non-transitory machine-readable medium may also be downloaded onto the computer or electronic device, where instructions may be transmitted from a remote server to the computer or electronic device over a data communication network.

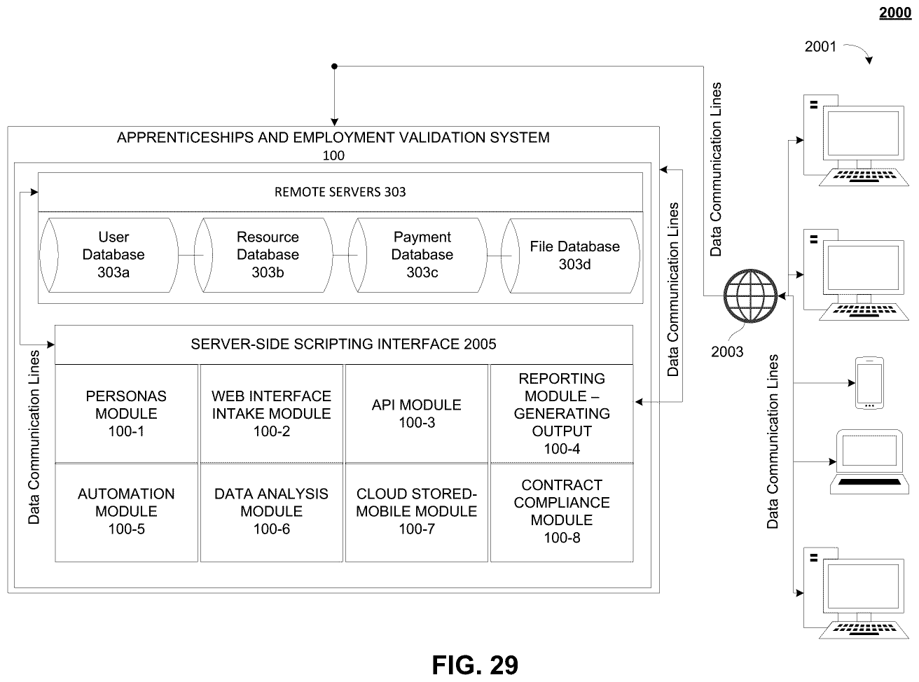

FIG. 29 illustrates a top level network 2000 of the system 100, according to an embodiment. In one instance, the system 100 may be accessible and connected to client computing devices 2001 over a public network connection (e.g., Internet) 2003. The client computing devices 2001 may interact with one or more service applications and other content rendered by the system 100 via a browser interface installed in the client computing devices 2001. Data 303 stored on one or more databases (303a-303d) of remote servers 303 may be accessed and retrieved via a server side scripting interface 2005 for facilitating apprenticeship and contract-based service requests made by the client computing devices 2001 to modules (100-1 to 100-8) in the system 100.

In sum, the system 100 and modules therein can be configured as a contract compliance tool as presented hereinabove, supporting many principal contract-based services in the vast service sectors to rapidly demonstrate its adaptability to reporting in complex matrixed environments. However, the system 100, subsystems, and methods thereof as described herein are not intended to be limited in their scope, implementation, application, or design for other tools required by contract-based services applications. In addition, the system 100, in part or in whole, may employ numerous combinations of hardware, software, external/internal data, data objects, resources, personnel, automation tools, and the like to accomplish many of its features and benefits presented in this document. Advantageously, the system 100 is optimally designed to generate cost and time savings for clients by centralizing a data repository which allows for the same information to be reconfigured and exported into a variety of reporting environments.

While particular embodiments of the present disclosure have been shown and described, it will be obvious to those skilled in the art that, based upon the teachings herein, changes and modifications may be made without departing from the exemplary embodiments of the present disclosure and their broader aspects. Therefore, the appended claims are intended to encompass within their scope all such changes and modifications as are within the true spirit and scope of these exemplary embodiments of the present disclosure.

What is claimed is:

1. A training and contract compliance validation system for managing at least one contract, the system comprising:
a personas module for defining user roles, privileges, and security level clearances to manage, create, and operate features, functions, and tasks offered by the system;
a web interface module serving as a primary portal through which personas may access apprenticeship resources and services facilitated by the system;
an API module for executing one or more requests in the system;
a reporting module for generating all pre-processed and pre-formatted reports tailored for each persona;
an automation module for automating tasks and control via predefined syntax commands to conduct automated updates, additions, and verification of data to and from one or more modules in the system;
a data analysis module for determining at least an ROI indicator of the system;
a cloud stored-mobile module for handling all file synchronization, storage, and backup services in the system; and
a contract compliance module for handling and managing at least a return-on-investment performance, an apprenticeship training performance, and a project compliance associated with the at least one contract.

2. The system of claim 1, wherein the personas module includes at least an Apprentice, a Reviewer, a Validator, a Program Coordinator, a Certifier, and an Analyst.

3. The system of claim 1, wherein the API module includes at least Reviewer API, a User API, a Certification API, a Task API, a Time Entry API, a Step API, an Step Instance API, a Session API, a Session Attendance API, a Task Instance API, a User Profile API, a User Payment API, a User Pay Rate API, a Reporting API, a Contracts API, a Project API, an Automation API, and a Data Analysis API.

4. The system of claim 1, wherein the ROI indicator is determined in real-time.

5. The system of claim 1, wherein a training program and an employment program is associated with the at least one contract, wherein at least one quantifiable value goal of the contract is predetermined.

6. The system of claim 1, wherein a contract validation indicator is determined based on compliance with the contract.

7. A computer-implemented method for managing a contract, executed by one or more processors in a computer network environment, comprising:
receiving a set of participant profile data from at least one participant associated with the contract, the contract involving a training program and an employment program, wherein at least one quantifiable value goal of the contract is predetermined;
supplementing the set of participant profile data with a pool of resource input data obtained from representatives within the training program and the employment program, including the at least one participant and at least one of a trainer or manager, as well as at least one representative outside of the training or the employment program;
reconciling, against the pool of resource input data, contract standards based on at least one of an individual education plan, a job readiness class requirement, a curriculum standard or an apprenticeship standard defined by a regulatory agency, and a particular contract requirement;
capturing at least one certification progress indicator associated with the training program and a level of performance data associated with the employment program;
synchronously performing the receiving, supplementing, reconciling and capturing steps for the set of participant profile data associated with the training program and the employment program that are subject to the contract;
using an algorithm to determine, in real-time, a return-on-investment indicator and a financial-competency indicator of the at least one participant over time for the contract based on the at least one quantifiable value goal, the at least one certification progress indicator and the level of performance data of the at least one participant;
simultaneously and in real-time determining a contract validation indicator based on compliance with the contract standards; and
prompting a course-correction where the contract validation indicator is not achieved.

8. The method of claim 7, wherein the at least one participant includes at least an apprentice who is enrolled in the training program.

9. The method of claim 7, wherein the pool of resource input data includes instructors of the training program, information on progress or milestones for determining financial and ROI metrics, and equipment of the training program.

10. The method of claim 7, wherein the at least one certification progress indicator is based on a progress measurement of the at least one participant toward achieving a certifications in the training program.

11. The method of claim 7, wherein the at least one quantifiable value goal is a measurable objective within the contract that two parties thereof aim to achieve.

12. The method of claim 7, wherein the contract validation indicator is a process of ensuring that performance of the contract meets all procurement, legal and regulatory requirements.

13. The method of claim 7, wherein the course-correction includes any adjustments or changes made to the training program when a progress of the at least one participant is not achieved.

14. A non-transitory, computer-readable storage medium that stores instructions, the instructions causing a computer to execute:
receiving a set of participant profile data from at least one participant associated with a contract, the contract involving a training program and an employment program, wherein at least one quantifiable value goal of the contract is predetermined;
supplementing the set of participant profile data with a pool of resource input data obtained from representatives within the training program and the employment program, including the at least one participant and at least one of a trainer or manager, as well as at least one representative outside of the training or the employment program;
reconciling, against the pool of resource input data, contract standards based on at least one of an individual education plan, a job readiness class requirement, a curriculum standard or an apprenticeship standard defined by a regulatory agency, and a particular contract requirement;
capturing at least one certification progress indicator associated with the training program and a level of performance data associated with the employment program;
synchronously performing the receiving, supplementing, reconciling and capturing steps for the set of participant profile data associated with the training program and the employment program that are subject to the contract;
using an algorithm to determine, in real-time, a return-on-investment indicator and a financial-competency indicator of the at least one participant over time for the contract based on the at least one quantifiable value goal, the at least one certification progress indicator and the level of performance data of the at least one participant;
simultaneously and in real-time determining a contract validation indicator based on compliance with the contract standards; and
prompting a course-correction where the contract validation indicator is not achieved.

15. The non-transitory, computer-readable storage medium of claim 14, wherein the at least one participant includes at least an apprentice who is enrolled in the training program.

16. The non-transitory, computer-readable storage medium of claim 14, wherein the pool of resource input data includes instructors of the training program, information on progress or milestones for determining financial and ROI metrics, and equipment of the training program.

17. The non-transitory, computer-readable storage medium of claim 14, wherein the at least one certification progress indicator is based on a progress measurement of the at least one participant toward achieving a certifications in the training program.

18. The non-transitory, computer-readable storage medium of claim 14, wherein the at least one quantifiable value goal is a measurable objective within the contract that two parties thereof aim to achieve.

19. The non-transitory, computer-readable storage medium of claim 14, wherein the contract validation indicator is a process of ensuring that performance of the contract meets all procurement, legal and regulatory requirements.

20. The non-transitory, computer-readable storage medium of claim 14, wherein the course-correction includes any adjustments or changes made to the training program when a progress of the at least one participant is not achieved.
